(19) United States
(12) Patent Application Publication
(10) Pub. No.: US 2008/0280672 A1
(43) Pub. Date: Nov. 13, 2008

(54) Gaming Machine

(75) Inventors: Jun FUJIMOTO, Tokyo (JP); Yukinori INAMURA, Tokyo (JP); Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/111,505

(22) Filed: Apr. 29, 2008

(30) Foreign Application Priority Data
May 8, 2007 (JP) 2007-123959

(51) Int. Cl. A63F 9/24; A63F 13/02; A63F 13/10

(52) U.S. Cl. 463/20; 463/31; 463/43

(57) ABSTRACT

A gaming machine includes a display device, a memory, and a controller. The controller is configured with logic to: (a) determine a combination of symbols to be displayed on the display device by performing a lottery in response to acceptance of manipulation to start the game by a player; (b) cause the display device to perform a variable display of symbols; (c) cause the display device to perform a statical display of the symbols in accordance with a result of the lottery; (d) when the statical display of the symbols matches a specific combination of symbols, control the memory to cumulatively store points. A number of the points is smaller than a threshold that is required for performing a special program that is adapted to provide profits to the player. When a summation of the points stored in the memory has reached the threshold, the controller executes the special program.

This application is based on and claims the benefit of priority from Japanese Patent Application No. 2007-123959, filed on 8 May 2007, the content of which is incorporated herein by reference.

### BACKGROUND OF THE INVENTION

1. Field of the Invention

The present invention relates to a gaming machine such as a slot machine that provides a game using a gaming medium (gaming value) such as coins or the like, the gaming machine paying out the gaming value such as credits to a player.

2. Related Art

In conventional slot machines, a game is started when a player bets a certain amount of credits. Then, a plurality of reels on which a plurality of symbols are arranged start to rotate, and are stopped after a predetermined lapse of time.

As a result, a certain award is provided to the player based on a symbol combination which is displayed statically.

However, the slot machine described in U.S. Pat. No. 6,599,193 performs a lottery in a single game, provides an award based on the result of the lottery, and terminates the single game. That is, the game provided by the slot machine is conclusive in each game. Therefore, since a player cannot acquire cumulative benefits obtained by accumulating game results over a plurality of games, the player cannot get a sense of accomplishment.

### SUMMARY OF THE INVENTION

The present invention has been made in view of the abovementioned problem. Accordingly, it is an object thereof to provide a novel slot machine that allows a player to acquire cumulative benefits obtained by accumulating game results over a plurality of games, thereby providing the player with a sense of accomplishment.

In order to solve the abovementioned problem, the present invention provides the following features.

In an aspect of the present invention, a gaming machine is provided, which pays an amount of game media for an occurrence of a predetermined combination of symbols as a result of a game. The gaming machine includes a display device, a memory, and a controller. The display device performs a variable display and a statical display of a plurality of symbols. The controller is configured with logic to: (a) determine a combination of symbols to be displayed on the display device as a result of a game by performing a lottery in response to acceptance of manipulation to start the game by a player; (b) cause the display device to perform a variable display of the plurality of symbols; (c) cause the display device to perform a statical display of the plurality of symbols in accordance with a result of the lottery; (d) when the statical display of the plurality of symbols matches a specific combination of symbols, control the memory to cumulatively store points. A number of the points is smaller than a threshold that is required for performing a special program that is adapted to provide profits to the player. When a summation of the points cumulatively stored in the memory has reached the threshold, the controller executes the special program.

As described above, a single game does not allow the player to obtain the points that satisfy the threshold for performing the special program. However, the gaming machine, which accumulates the points for occurrences of the specific combination of symbols, executes the special program when the summation of the points has reached the threshold. Since the gaming machine accumulates the points over a plurality of games, it allows the player to feel a sense of accomplishment to earn profits through the special program according to an accumulated amount of points.

In another aspect of the present invention, a method for playing a game is provided, which pays an amount of game media for an occurrence of a predetermined combination of symbols as a result of the game. The method includes: (a) accepting manipulation to start a game by a player; (b) starting the game in response to step (a); (c) determining a combination of symbols to be displayed on a display device that performs a variable display and a statical display of a plurality of symbols as a result of a game by performing a lottery; (d) causing the display device to perform a variable display of the plurality of symbols; (e) causing the display device to perform a statical display of the plurality of symbols in accordance with a result of the lottery; (f) when the statical display of the plurality of symbols matches a specific combination of symbols, controlling a memory to store points that are required for performing a special program that is adapted to provide profits to the player; and (g) when a summation of the points cumulatively stored in the memory has reached a threshold, executing the special program.

### BRIEF DESCRIPTION OF THE DRAWINGS

FIGS. 1A and 1B show an example of images illustrating a point value cumulatively stored in a memory;

FIG. 2 is a perspective view of a slot machine 1 of the first embodiment;

FIG. 3 is a longitudinally-sectional view of the main display 4 and reels 22;

FIG. 4 is an exploded perspective view of the main display 4;

FIG. 5 is a view showing symbols drawn on the reels 22L, 22C, and 22R, and code numbers;

FIG. 6 is a view showing an electric configuration of the slot machine 1 of the first embodiment;

FIG. 7 is a view showing an electrical configuration of a sub control circuit 171 of the slot machine 1 of the first embodiment;

FIG. 8 is a flowchart showing a routine of game execution processing of the slot machine 1;

FIG. 9 is a flowchart showing a subroutine of lottery processing which is called to execute in the game execution processing shown in FIG. 8;

FIG. 10 is a flowchart showing a subroutine of the win determination processing 1, which is called to execute in the game execution processing shown in FIG. 8;

FIG. 11 is a flowchart showing a subroutine of bonus game processing, which is called in win determination processing 1 as shown in FIG. 10;

FIG. 12 is a flowchart showing a subroutine of payout processing, which is called in win determination processing 1 as shown in FIG. 10;

FIG. 13 is a flowchart showing a subroutine of point addition processing which is called to execute in win determination processing as shown in FIG. 10;

FIGS. 14A and 14B are examples of images representing a trigger rendered effect 1 displayed on the main display 4 and the sub display 3;

FIGS. 15A and 15B show examples of images of the WIN rendered effect 1 displayed on the main display 4 and the sub display 3;

FIGS. 16A and 16B are examples of images representing a trigger rendered effect 2 displayed on the main display 4 and the sub display 3;

FIG. 17 is a flowchart showing a subroutine of payout processing 2 (processing regarding HALF WILD) as an example of payout processing, which is called in win determination processing as shown in FIG. 10;

FIG. 18 is an example of an image representing a trigger rendered effect 3 displayed on the main display 4;

FIG. 19 is an example of an image representing a WIN rendered effect 2 displayed on the main display 4;

FIG. 20 is an example of an image (a gauge type) displaying the obtained point on the sub display 3;

FIG. 21 is an example of an image (numeral value display type) displaying the obtained point on the sub display 3;

FIG. 22 is an example of an image (appearance of a gauge for each winning combination) displaying the obtained point on the sub display 3;

FIG. 23 shows symbols arranged on reels 22L, 22C, and 22R (including a “RANKUP!” symbol), and code numbers;

FIG. 24 is a flowchart showing a subroutine of win determination processing 2 with regard to “RANK UP!”;

FIG. 25 is a flowchart showing a subroutine of payout rate change processing for a symbol applicable to point addition which is called to execute in win determination processing 2 as shown in FIG. 24;

FIGS. 26A and 26B are examples of images showing the RANK UP effect 1 displayed on the main display 4 and the sub display 3;

FIGS. 27A and 27B are examples of images showing the RANK UP effect 2-1 displayed on the main display 4 and the sub display 3;

FIGS. 28A and 28B are examples of images of the RANK UP effect 2-2 displayed on the main display 4 and the sub display 3;

FIGS. 29A and 29B are examples of images of the WHEEL effect 1-1 displayed on the main display 4 and the sub display 3;

FIGS. 30A and 30B are examples of images of the WHEEL effect 1-2 displayed on the main display 4 and the sub display 3 in a case where a game has been executed and advanced from FIG. 29;

FIGS. 31A and 31B are examples of images showing the WHEEL effect 2 displayed on the main display 4 and the sub display 3 in a case where a rearranged combination matches a WHEEL winning combination;

FIG. 32 is a flowchart showing a subroutine of the win determination processing (WILD Effect processing), which is called to execute in game execution processing shown in FIG. 8;

FIG. 33 shows a transition of images displaying the HALF WILD effect displayed on the main display 4;

FIG. 34 is a perspective view of a slot machine 1 of the second embodiment;

FIG. 35 is a block diagram schematically showing the control system of the slot machine 1 of the second embodiment;

FIG. 36 is a diagram showing a symbol and a code number displayed on the first sub reel 26;

FIG. 37 is a flowchart showing a subroutine of win determination processing 4, which is called to execute in game execution processing shown in FIG. 8;

FIG. 38 is an example of an image of the first sub reel effect 1 displayed on the main display 4;

FIG. 39 is an example of an image of the first sub reel effect 1 displayed on the main display 4 in a case where a game has been executed and advanced from FIG. 38;

FIG. 40 shows symbols and code numbers displayed on the first sub reel 26 and the second sub reel 27;

FIG. 41 is a flowchart showing a subroutine of win determination processing 5 which is called to execute in game execution processing shown in FIG. 8;

FIG. 42 is an example of an image of the first and second sub reels effect 1-1 displayed on the main display 4;

FIG. 43 is an example of an image of the first and second sub reels effect 1-2 displayed on the main display 4 in a case where a game has been executed and advanced from FIG. 42;

FIG. 44 is an example of an image of the first and second sub reels effect 1-3 displayed on the sub display 3 in a case where a game has been executed and advanced from FIG. 43;

FIG. 45 is an example of an image of the first and second sub reels effect 1-4 displayed on the sub display 3 in a case where a game has been executed and advanced from FIG. 44;

FIGS. 46A and 46B are examples of images of the first and second sub reels effect 2 displayed on the main display 4 and the sub display 3;

FIG. 47 is a perspective view of the video slot 1;

FIG. 48 is a block diagram schematically showing the control system of the video slot 1;

FIGS. 49A and 49B are examples of images showing a free game effect 1 displayed on the main display 4 and the sub display 3;

FIG. 50 is an example of an image of a free game effect 2-1 displayed on the main display 4;

FIG. 51 is an example of an image of the free game effect 2-2 displayed on the main display 4 in a case where a game has been executed and advanced from FIG. 50;

FIG. 52 is a flowchart showing a subroutine of progressive payout processing; and

FIGS. 53A and 53B are examples of images showing the trigger rendered effect 4 displayed on the main display 4 and the sub display 3.

### DETAILED DESCRIPTION OF THE INVENTION

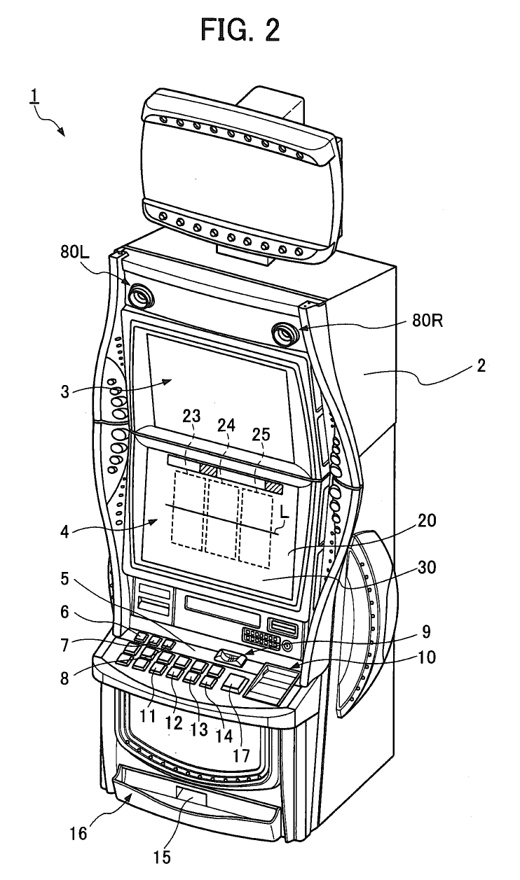

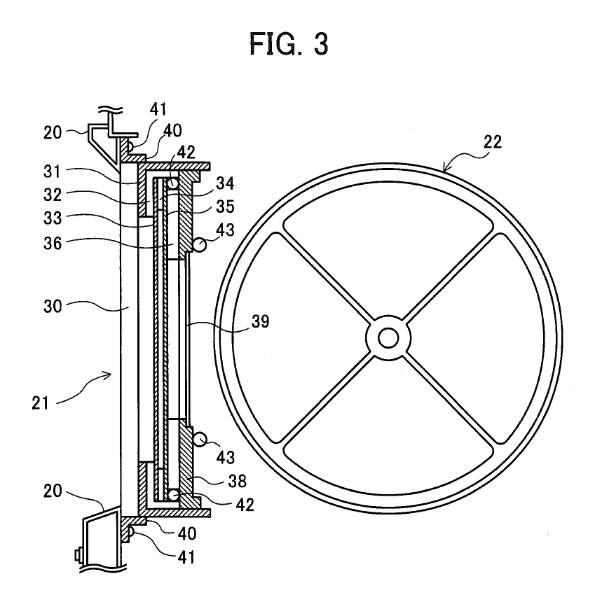

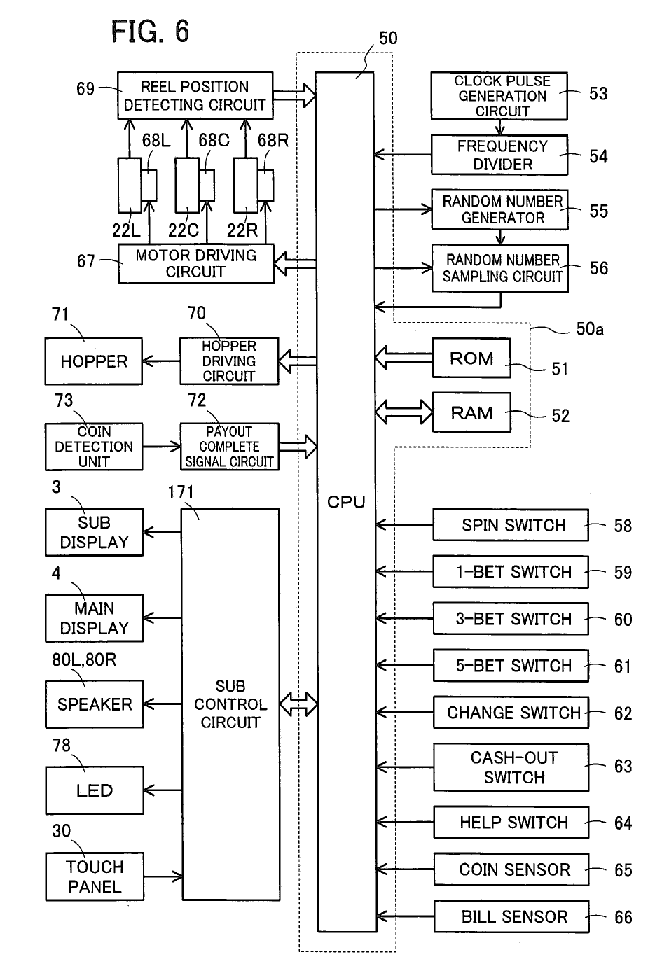

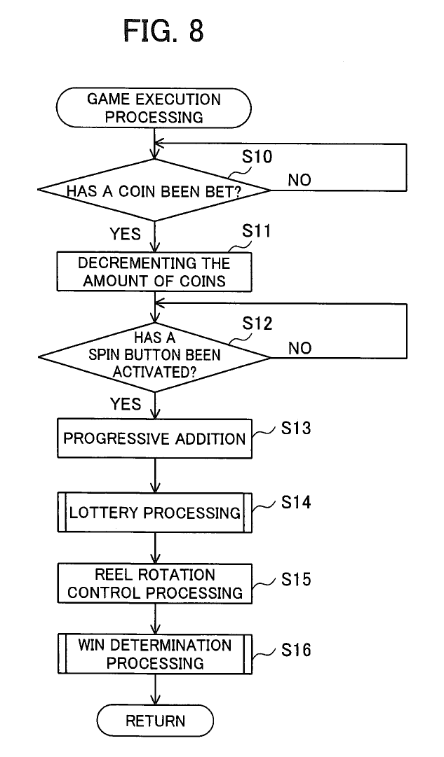

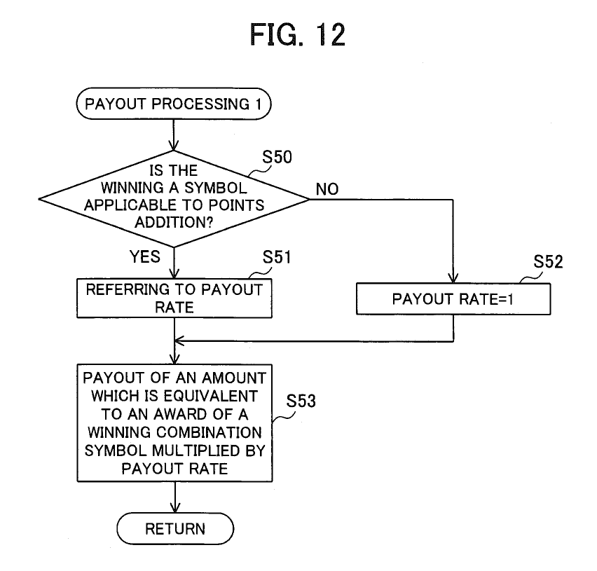

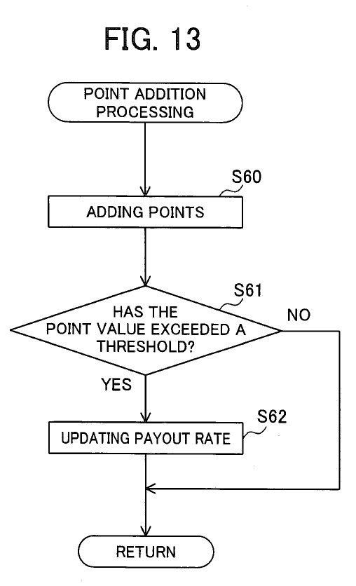

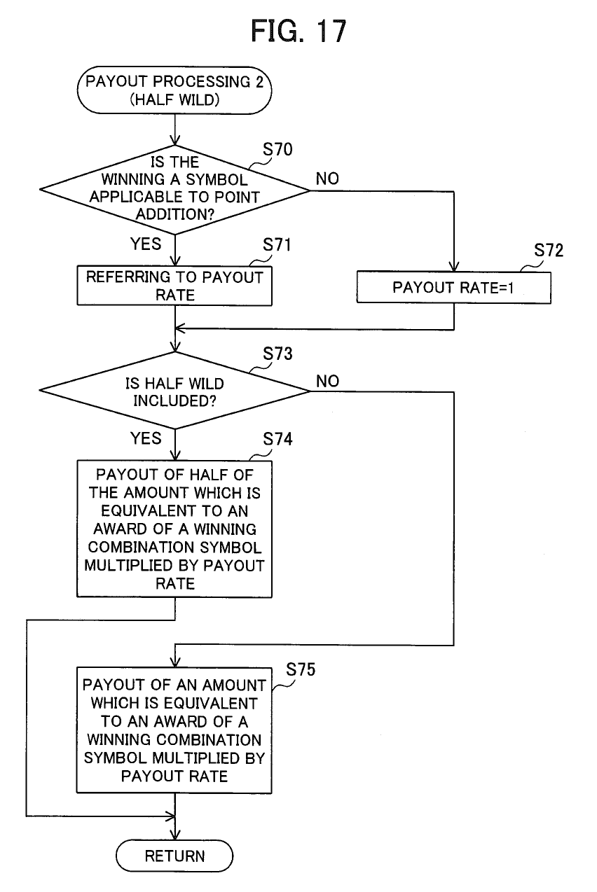

In the present embodiment, a slot machine 1 as a gaming machine is provided with a main display 4 for displaying variably and statically a plurality of symbols (which is referred to as “rearranging”, hereinafter), display windows 23, 24, and 25, a plurality of reels 22L, 22C, and 22R having a plurality of symbols on each surface thereof, and a plurality of motors 68 for rotating and stopping the plurality of reels in response to reception of a signal, a 1-bet button 11, a 3-bet button 13, and a 5-bet button 14 for accepting bets of credits, and RAM 52 for cumulatively storing a portion of the bet of credits thus accepted (FIGS. 2 and 6 which are described later). The slot machine 1 processes a lottery of random numbers in response to an input to a spin/repeat-bet button 17 (hereinafter, abbreviated to “spin button”) by a player in lottery processing (Step S14 in FIG. 8, which is described later), starts a game, causes rotation of the plurality of reels to stop in reel rotation control processing (Step S15 in FIG. 8, which is described later), and rearranges the plurality of symbols. Then, a controller (CPU 50 in FIG. 6, which is described later) of the slot machine 1 causes memory to cumulatively store a point value when a specific symbol combination is displayed statically on the main display 4 (Step S60 of point addition processing in FIG. 13, which is described later). This point value is lower than an amount of point value required to execute a special program for providing a benefit to a player. In addition, the controller executes a special program when the amount of point values cumulatively stored in the memory reaches the point value required to execute the special program (Step S62 of point addition processing in FIG. 13, Steps S51 and S53 of payout processing 1 in FIG. 12, or Steps S71, S74, and 75 of payout processing 2 in FIG. 17, which are described later). Therefore, the slot machine 1 adds point values as a game result, updates a payout rate when the result of adding exceeds a threshold, and pays out credits for a predetermined symbol combination based on the payout rate so that a player can acquire cumulative benefits obtained by accumulating game results over a plurality of games, thereby allowing the player to feel a sense of accomplishment.

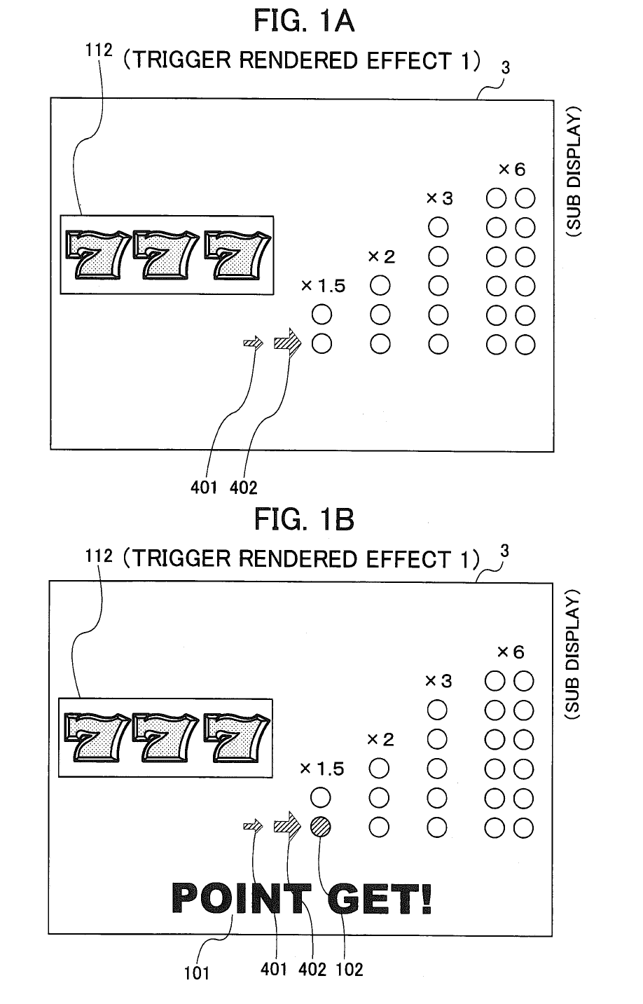

FIG. 1 shows an example of an image illustrating that a point value is cumulatively stored in a memory.

FIGS. 1A and 1B show an example of images displayed on a sub display 3 illustrating that a point value which is lower than the point value required for executing a special program is cumulatively stored in a memory. The image displayed on the sub display 3 shown in FIG. 1A represents accumulation up to the point value required for executing a special program, an obtained point value to execute the special program, a payout rate, and a symbol combination for a payout. The required point value to execute the special program is represented with arrow marks 401 and 402. The point value to execute the special program is represented with an open circle. The payout rate is represented with “×1.5”, “×2”, “×3”, and “×6”. The symbol combination of payout is represented as “7, 7, 7”. Oblique lines in arrow marks 401 and 402 in the image shown in FIG. 1A indicates that the currently accumulated point value is 2 for a case where the required point value to execute the special program is 3, for example.

FIG. 1B shows an example of an image displayed on the sub display 3 illustrating that as a result of cumulatively storing a point value, which is lower than the point value (a threshold) required to execute the special program in the memory, the cumulative point value reaches the point value (the threshold). The image displayed on the sub display 3 shown in FIG. 1B is an example, in which oblique lines in the circle 102 indicate that additional games have been performed following the game shown in FIG. 1A, the point value reaches the threshold.

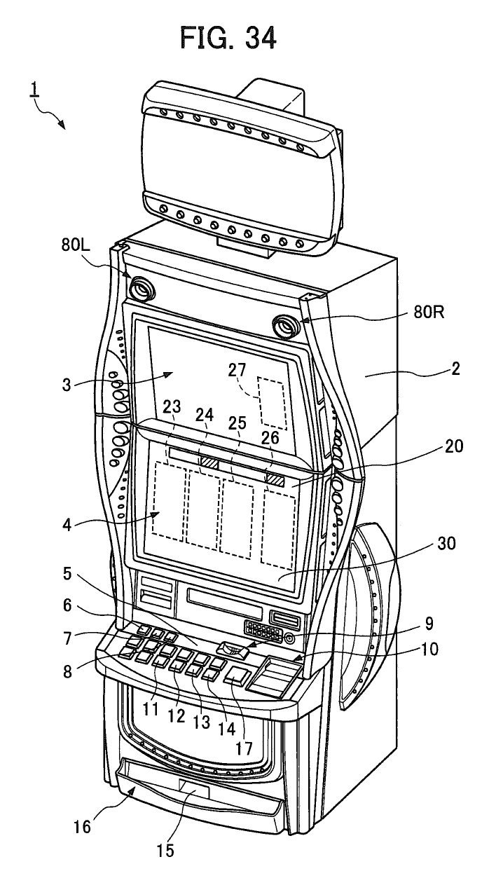

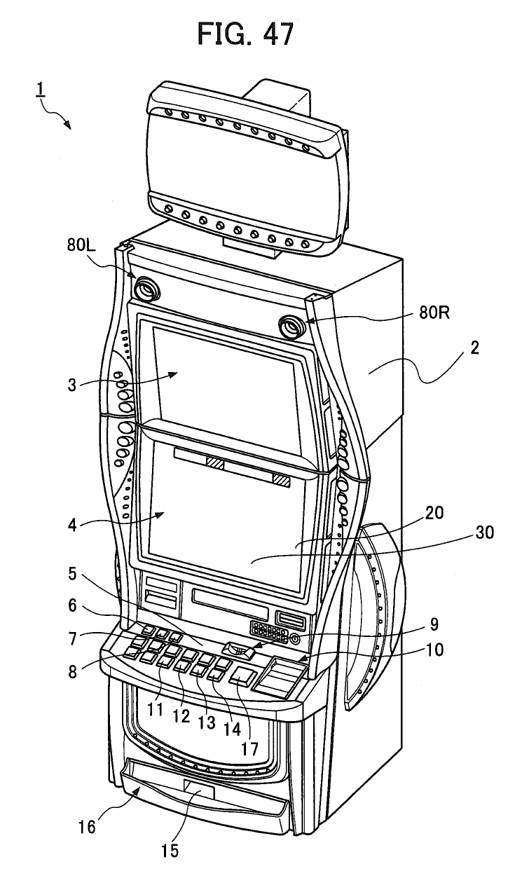

Although the present embodiment describes a case in which the reels (the display windows 23, 24, and 25) in FIG. 2 (described later) are included, the present embodiment can be implemented similarly in a slot machine provided with sub reels 26 and 27 in FIG. 34 (described later) and a video slot in FIG. 47 (described later).

### First Embodiment

A slot machine 1 according to the present embodiment is described below in reference to FIGS. 2 to 33. Firstly, an outline of the configuration of the slot machine 1 according to the embodiment is described on the basis of FIGS. 2 and 6.

### Exterior Appearance of Slot Machine 1

FIG. 2 is a perspective view of the slot machine 1.

In FIG. 2, the slot machine 1 has a cabinet 2 which forms the whole body thereof, and a sub display 3 disposed front on an upper portion of the cabinet 2. In addition, a main display 4 is disposed front on a center portion of the cabinet 2.

Here, the sub display 3 is configured by a liquid crystal display, which is generally used. In addition, the main display 4 is configured by a transparent liquid crystal display, which is described later. Meanwhile, a detailed structure of the main display 4 is described later. A payout table, which is described later, is displayed on the sub display 3, in a case of a normal gaming state and a waiting state.

On a lower side of the main display 4, an operation table 5 projecting toward a front side is disposed. On the operation table 5, a CHANGE button 6, a CASH-OUT button 7, and a HELP button 8 are disposed from a leftmost side. In addition, on the right side of the HELP button 8, a coin insertion slot 9 and a bill insertion slot 10 are disposed. In addition, on the front side of the operation table 5, a 1-BET button 11, a SPIN/REPEAT-BET button (hereinafter referred to as “SPIN button”) 12, a 3-BET button 13, and a 5-BET button 14 are disposed from a left side.

Here, the CHANGE button 6 is pressed when exchanging the bill inserted into the bill (or paper money) insertion slot 10, and the exchanged coins are paid out to a coin tray 16 through a coin payout opening 15, which is disposed at a lower portion of the cabinet 2. A CHANGE switch 62 (described later) is attached to the CHANGE button 6, and a switch signal is output to a CPU 50 from the CHANGE switch 62 in response to pressing of the CHANGE button 6.

The CASH-OUT button 7 is usually pressed when a normal game is terminated. When the CASH-OUT button 7 is pressed, coins obtained in a game are paid out from the coin payout opening 15 to the coin tray 16. Meanwhile, a payout (CASH-OUT) switch 63 (described later) is attached to the CASH-OUT button 7, and a switch signal is output to the CPU 50 in response to pressing of the CASH-OUT button 7.

The HELP button 8 is pressed when it is unclear to the player how to play the game. When the HELP button 8 is pressed, various help information is displayed on the sub display 3 and the main display 4. A HELP switch 64, which is described later, is attached to the HELP button 8. A switch signal is output to the CPU 50 from the HELP switch 64 in response to pressing of the HELP button 8.

Meanwhile, when a payout table, which is described later, is not displayed on the sub display 3 in the game, the payout table is displayed on the sub display 3 through pressing of the HELP button 8.

A coin sensor 65, which is described later, is disposed in the coin insertion slot 9. When a coin is inserted in the coin insertion slot 9, a coin detection signal is output to the CPU 50 from the coin sensor 65. In addition, a bill sensor 66 is disposed in the bill insertion slot 10. When a bill is inserted into the bill insertion slot 10, a bill detection signal is output to the CPU 50 from the bill sensor 66.

As for the 1-BET button 11, every time the 1-BET button 11 is pressed one credit is bet, and betting can be done by pressing the 1-BET button 11 up to three times as the maximum pressing time. A 1-BET switch 59 is attached to this 1-BET button 11. When the 1-BET button 11 is pressed, a switch signal is output from the 1-BET switch 59 to the CPU 50 in response to pressing of the 1-BET button 11.

The SPIN button 17 initiates rotation of the reels 22L, 22C, 22R (described later) so as to start a game with a current bet amount or a previous bet amount in response to pressing of the SPIN button 17. A SPIN switch 58 (described later) is attached to the SPIN button 17. When the SPIN button 17 is pressed, a switch signal is output from the SPIN switch 58 to the CPU 50 in response to pressing of the SPIN switch 58.

Here, as the bet amount, which can be bet by press of the SPIN button 17, there may exist 1 bet, 2 bets, 3 bets, and 5 bets.

The 3-BET button 13 is a button to start a game with 3 bets. A 3-BET switch 60 (described later) is attached to the 3-BET button 13. When the 3-BET button 13 is pressed, a switch signal is output from the 3-BET switch 60 to the CPU 50.

In addition, the 5-BET button 14 is a button to be pressed when starting a game with 5 bets, and when starting a bonus game, which is described later. A 5-BET switch 61 (described later) is attached to the 5-BET button 14. A switch signal is output from the 5-BET switch 61 to the CPU 50 in response to pressing of the 5-BET button 14.

In addition, the cabinet 2 has the coin payout opening 15 and a coin tray 16 at the lower part thereof. The coin tray 16 receives a coin paid out from the coin payout opening 15. A coin detection unit 73, which is configured with a sensor and the like, is disposed inside of the coin payout opening 15, and detects the number of coins paid out from the coin payout opening 15.

### Reel and Main Display

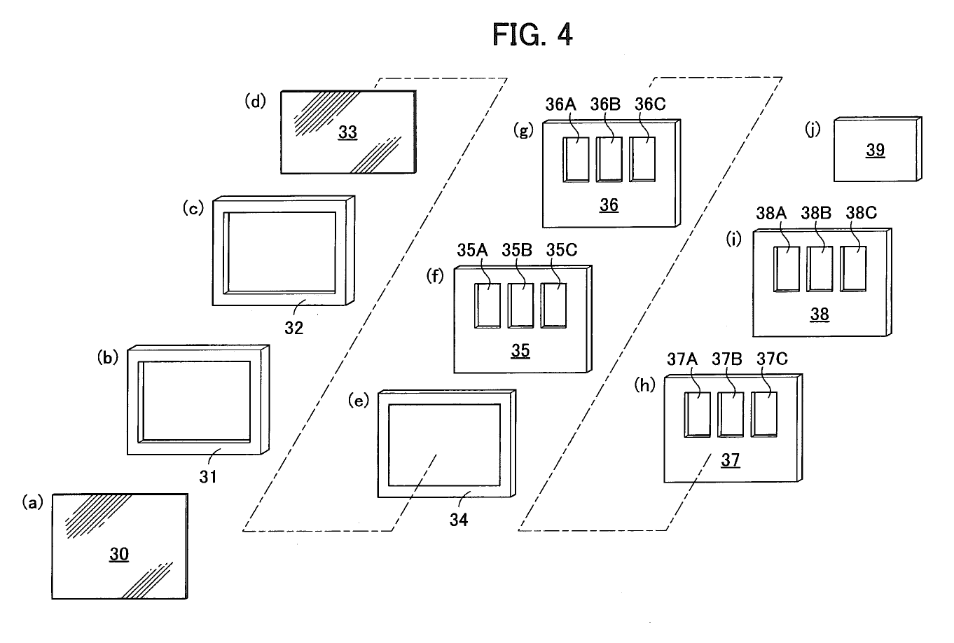

Subsequently, a detailed structure of the main display 4 and the three reels 22L, 22C, and 22R, which are disposed rotatably inside of the cabinet 2 on a back surface side of the main display 4, is described according to FIGS. 3 and 4.

FIG. 3 is a longitudinal-sectional view of the main display 4 and the reels 22L, 22C, and 22R. FIG. 4 is an exploded perspective view of the main display 4.

In FIGS. 3 and 4, the main display 4, together with a transparent touch panel 30 (hereinafter, referred to as “touch panel 30”) that is arranged on a front side (left side in FIG. 3) of the main display 4, is disposed within a display window section 21 of a device front panel 20 disposed front at a center portion of the cabinet 2 of the slot machine 1. In addition, on a back side (right side in FIG. 3) of the main display 4, the three reels 22L, 22C, and 22R (FIG. 3 shows only one reel among the three reels 22L, 22C, and 22R) are supported in parallel, each of which is supported so as to rotate independently.

Here, each of the reels 22L, 22C, and 22R is described. Among the three reels 22L, 22C, and 22R, the reel 22L of the slot machine 1 faces a left display window 23 (see, FIG. 2), which is formed in the main display 4. The reel 22C faces a center display window 24 (see, FIG. 2), which is formed in the main display 4. Similarly, the reel 22R faces a right display window 25 (see, FIG. 2), which is formed in the main display 4.

Structure of respective display windows 23, 24, and 25 is described later in Structure of Main Display.

### Symbol Lines of Reels

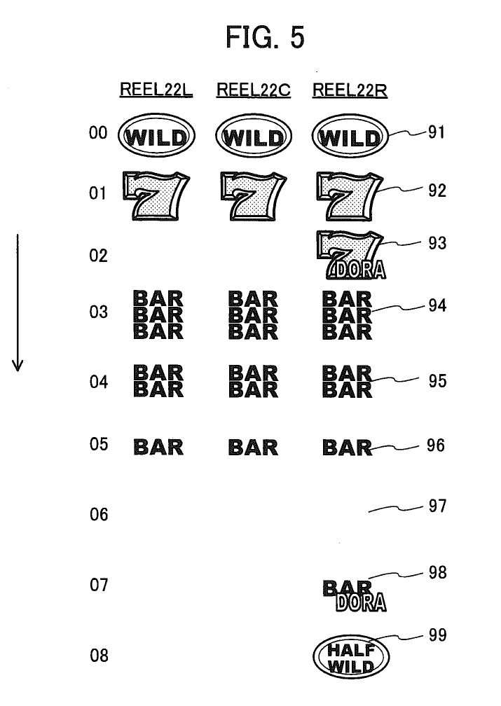

FIG. 5 shows one example of symbol lines in which nine pieces of plural types of symbols arranged on the respective reels 22L, 22C, and 22R. This arrangement is converted into a table as data and stored in ROM 51 (see, FIG. 6), which is described later. That is, code numbers of “00” to “08” are given to each symbol as shown in FIG. 5, and stored in the ROM 51 as a data table (see, FIG. 6), which is described later.

In other words, it is possible to specify a symbol uniquely, by identification of the reels 22L, 22C, and 22R, and the code numbers.

On a peripheral surface of each of the reels 22L, 22C, and 22R, nine types of symbols including a blank symbol are depicted as shown in FIG. 4. More specifically, the symbols, which are formed on a peripheral surface of each of the reels 22L, 22C, and 22R, are a WILD symbol 91, a RED 7 symbol 92, a 7 DORA symbol 93, a 3 BAR symbol 94, a 2 BAR symbol 95, a BAR symbol 96, a blank symbol 97, a BARDORA symbol 98, and HALF WILD symbol 99. Then, on a peripheral surface of each of the reels 22L, 22C, and 22R, these nine types of symbols are arranged in the order shown in FIG. 5. Each of the reels 22L, 22C, and 22R is driven to rotate in such a manner that a symbol line moves in the direction of an arrow in FIG. 5.

In addition, various winning combinations have been set up in advance based on a plurality of types of combinations of each symbol. When a symbol combination corresponding to a winning combination comes to rest along a pay line L (see FIG. 2), coins are paid out from the coin payout opening 15 according to the winning combination. These points are the same as those in a conventional slot machine, and therefore an explanation thereof is omitted. In addition, regarding the various symbols formed on a peripheral surface of each of the reels 22, it is a typical way that a long seal printed with nine pieces of symbols, which has a width and a peripheral length fit for each of the reels 22, is bonded to the peripheral surface of each of the reels 22. However, it may be alternatively possible to form the symbols in different manners.

In this embodiment, only a center line is selected for the pay line L. The pay line L is displayed on the main display 4 when games are carried out by rotating and stopping the reels 22 in response to pressing of the 1-BET button 11, the 3-BET button 13, and the 5-BET button 14 or the SPIN button 17. On the other hand, the pay line L is eliminated from the main display 4 for a bonus game which is performed in response to pressing of the 5-BET button 14 when a player is entitled to various bonus games.

In addition, the BONUS trigger symbol 93 (7 DORA symbol) is the one which serves as a trigger for the purpose of achieving various bonus games. In this embodiment, one BONUS trigger symbol 93 is arranged only on a peripheral surface of the reel 22R. When the BONUS trigger symbol 93, which exists on the peripheral surface of the reel 22R, comes to rest on the pay line L, a player is entitled to various bonus games.

### Structure of Main Display 4

Subsequently, a structure of the main display 4 is described according to FIGS. 3 and 4. In FIGS. 3 and 4, the main display 4 is configured with the following components arranged from the front side of the slot machine 1: a touch panel 30, a reel glass base 31, a bezel metal frame 32, a liquid crystal panel 33, a liquid crystal holder 34, a diffusion sheet 35, a light guiding plate 36, a white reflector 37, a rear holder 38, and an anti-static sheet 39. In the diffusion sheet 35, openings 35A, 35B, and 35C are formed. Similarly, in the light guiding plate 36, the reflector 37 and the rear holder 38, three openings 36A to 36C, three openings 37A to 37C, and three openings 38A to 38C are formed, respectively, so as to be aligned with the openings 35A, 35B, and 35C. Here, the openings 35A to 38A configure the left display window 23 (see FIG. 2. Similarly, the openings 35B to 38B and the openings 35C to 38C configure the center display window 24 and the right display window 25 (see FIG. 2), respectively.

Here, the openings 35A to 35C in the diffusion sheet 35 and the openings 36A to 36C in the light guiding plate 36 configure the light transmitting areas to retain visibility while variable display is being conducted by each rotating reel 22.

In order to install the main display 4 to the display window 21 of the device front panel 20, as shown in FIG. 3, brackets 40 extending in upward and downward directions of the reel glass base 31 are screwed to the rear side of the device front panel 20 by screws 41.

In addition, a pair of cold cathode ray tubes 42 is disposed as a light source of the liquid crystal panel 33, at upper and lower ends of the light guiding plate 36.

In addition, a pair of cold cathode ray tubes 43, which illuminates symbols formed on an outer peripheral surface of each reel 22, is disposed at upper and lower positions on the rear side of each of the openings 38A to 38C in the rear holder 38.

The liquid crystal panel 33 is a transparent electric display panel on which transparent electrodes such as ITO are formed, and arranged in front of each of the reels 22 which can be seen therethrough. The circumference of the rear side of the display part of the liquid crystal panel 33 is held by the liquid crystal holder 34. In the light guiding plate 36, which is made of a light transmitting resin panel, lens cut portions are formed. The lens cut portions lead light emitted from the cold cathode ray tubes 43 positioned at end positions of the light guiding plate 36 to the rear side of the liquid crystal panel 33. The diffusion sheet 35, which is made of a light transmitting resin sheet, scatters light led by the light guiding plate 36 and levels light irradiated to the liquid crystal panel 33. The liquid crystal holder 34 for holding the liquid crystal panel 33, the diffusion sheet 35, and the light guiding plate 36 are assembled into a one-piece construction, with the circumference thereof inserted in a bezel metal frame 32. Thereby, the front side of the display part in the liquid crystal panel 33 is retained by the bezel metal frame 32.

The circumference of the liquid crystal holder 34, the light diffusion sheet 35, and the light guiding plate 36 is further inserted into the reel glass base 31. In this way, the reel glass base 31 holds these components in a state in which the front display plane of the liquid crystal panel 33 is open. The touch panel 30 is attached in pressure contact to the front side of the reel glass base 31, which is attached to the device front panel 20 by way of the screws 41.

The rear holder 38 made of a white resin plate retains the bezel metal frame 32 supported by the reel glass base 31, the liquid crystal holder 34 holding the liquid crystal panel 33, the light diffusion sheet 35, and the light guiding plate 36 to the reel glass base 31 from the rear side thereof. The rear holder 38 also functions as a reflecting plate for reflecting light emitted from the cold cathode ray tubes 42 to the light guiding plate 36 toward the liquid crystal panel 33. The anti-static sheet 39, which is transparent and adhered to the rear plane of the rear holder 38 by way of double-sided adhesive tape, covers the rear plane of each of the openings 38A to 38C formed in the rear holder 38.

### Electric Configuration of Slot Machine 1

Next, the configuration of the control system in the slot machine 1 is described with reference to FIG. 6. FIG. 6 is a block diagram schematically showing the control system in the slot machine 1.

In FIG. 6, the control system of the slot machine 1 is basically configured from the CPU 50. ROM 51 and RAM 52 are connected to the CPU 50. A main control circuit 50a of the slot machine 1 is configured with the CPU 50, the ROM 51, and the RAM 52. The ROM 51 stores a game control program (described later), various effect programs and effect data for executing various effects on the sub display 3 and the main display 4 according to progress in games, a probability table (not shown) for conducting a lottery of various winning combinations, various programs necessary for controlling the slot machine 1, and various data tables and the like. In addition, the RAM 52 is a memory for temporarily storing various data computed by the CPU 50.

In addition, a clock pulse generation circuit 53 for generating standard clock pulses and a frequency divider 54 are connected to the CPU 50, and a random number generator 55 and a random number sampling circuit 56 are also connected to the CPU 50. A random number sampled by the random number sampling circuit 56 is utilized in various lotteries of the winning combinations, the effects, and the like. Furthermore, the spin switch 58 attached to the SPIN button 17, the 1-BET switch 59 attached to the 1-BET button 11, the 3-BET switch 60 attached to the 3-BET button 13, the 5-BET switch 61 attached to the 5 BET-button 14, the change switch 62 attached to the change button 6, the cashout switch 63 attached to the CASH-OUT button 7, and the help switch 64 attached to the help button 8 are connected to the CPU 50, respectively. The CPU 50 controls the slot machine 1 to execute various operations corresponding to each button, based on a switch signal output from each switch when each button is pressed.

Furthermore, the coin sensor 65, which is disposed in the coin insertion slot 9, and the bill sensor 66, which is disposed in the bill insertion slot 10, are connected to the CPU 50, respectively. The coin sensor 65 detects a coin inserted from the coin insertion slot 9, and the CPU 50 computes the amount of coins inserted based on a coin detection signal output from the coin sensor 65. The bill sensor 66 detects a type and an amount of a bill inserted from the bill insertion slot 10, and the CPU 50 computes an amount of coins which is equivalent to the amount of a bill based on a bill detection signal output from the bill sensor 66.

Three stepping motors 68L, 68C, and 68R, which are driven through a motor driving circuit 67 to rotate the reels 22L, 22C, and 22R, respectively, are connected to the CPU 50. In addition, a reel position detection circuit 69 is connected to the CPU 50. When a motor driving signal is output from the CPU 50 to the motor driving circuit 67, each of the stepping motors 68 is driven so as to rotate by the motor drive circuit 67. Thereby, each of the reels 22L, 22C, and 22R is rotated.

At this time, after each of the reels 22L, 22C, and 22R starts to rotate, the number of driving pulses supplied to each of the stepping motors 68 is calculated, and the calculated value is written in a predetermined area of the RAM 52. In addition, a reset pulse is output from each of the reels 22L, 22C, and 22R with respect to each one spin, and the reset pulse is input to the CPU 50 through the reel position detection circuit 69. When the reset pulse is input to the CPU 50, the calculated value written in the RAM 52 is cleared to “0”, and the CPU 50 recognizes a rotation position of symbols on each of the reels 22L, 22C, and 22R, based on the calculated value corresponding to the rotational position of each of the reels 22L, 22C, and 22R within one rotation, and a symbol table in which the rotational position of each of the reels 22L, 22C, and 22R stored in the ROM 51 and the symbols formed on a peripheral surface of each of the reels 22L, 22C, and 22R correspond with each other.

A hopper 71 is connected to the CPU 50 through a hopper driving circuit 70. When the CPU 50 outputs a driving signal to the hopper driving circuit 70, the hopper 71 pays out a predetermined amount of coins through the coin payout opening 15.

In addition, a coin detection unit 73 is connected to the CPU 50 through a payout complete signal circuit 72. The coin detection unit 73 is disposed inside of the coin payout opening 15. When the coin detection unit 73 detects a predetermined amount of coins paid out from the coin payout opening 15, a coin payout detection signal is output from the coin detection unit 73 to the payout complete signal circuit 72. Based on this signal, the payout complete signal circuit 72 outputs a payout complete signal to the CPU 50.

In addition, a sub control circuit 171 is connected to the CPU 50. The sub display 3, the main display 4, speakers 80L and 80R, an LED 78, and the touch panel 30 are connected to the sub-control circuit. In addition, two-way communication is carried out between the CPU 50 and the sub-control circuit 171.

### Electric Structure of Sub-Control Circuit

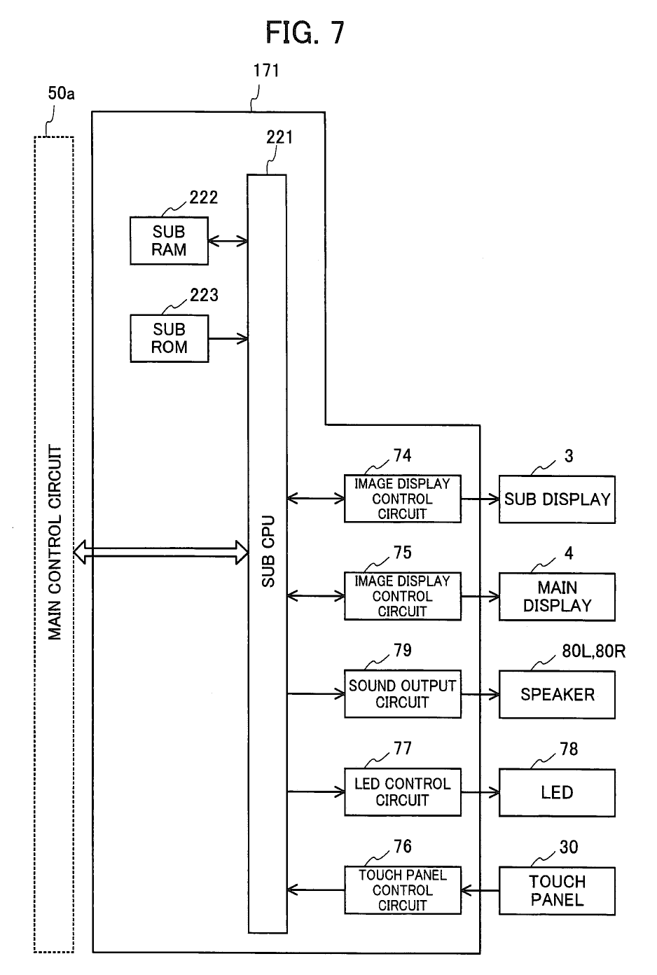

Next, the sub-control circuit 171 shown in FIG. 7 is described. The sub-control circuit 171 is configured by a sub CPU 221, sub ROM 223, sub RAM 222, image display control circuits 74 and 75, a sound output circuit 79, an LED control circuit 77, and a touch panel control circuit 76. In addition, an IN port and an OUT port, etc. are disposed arbitrarily between the main control circuit 50a and the sub-control circuit 171, and between the sub CPU 221 and each actuator.

The sub CPU 221 determines what is displayed on the sub display 3 and the main display 4 based on a gaming information command transmitted from the main control circuit 50a, and transmits content to be displayed to the image display control circuits 74 and 75.

The sub ROM 223 stores a communication sequence program for communicating with the main control circuit 50a, and a program and data necessary for a slot game and a bonus game.

The sub RAM 222 is used as a working area for executing these control programs.

The image display control circuit 74 that includes video ROM (not shown) and video RAM (not shown) controls content to be displayed on the sub display 3. The image display control circuit 75 that also includes video ROM (not shown) and video RAM (not shown) controls content to be displayed on the main display 4. The image display control circuits 74 and 75 cause the sub display 3 and the main display 4 respectively to display predetermined rendered effects based on various effect commands transmitted from the main control circuit 50a.

The sound output circuit 79 that includes a sound source ROM (not shown) and work RAM (not shown) controls sound output to the speakers 80L and 80R. The sound output circuit 79 makes the speakers 80L and 80R generate predetermined audio based on various audio effect commands transmitted from the main control circuit 50a.

The LED control circuit 77 controls light emitted from various LEDs 78 which decorate a game of the slot machine 1. The LED control circuit 77 makes the LED 78 emit light with predetermined timing, based on various LED effect commands transmitted from the main control circuit 50a.

The touch panel control circuit 76 controls the touch panel 30 and detects that a player has touched a predetermined touch area image, and then conveys the detection to the sub CPU 221. Then, the sub CPU 221 performs predetermined control of images to allow various games to be performed and continued on the sub display 3 and the main display 4.

In addition, in this embodiment, the sub control circuit 171, which is independent from the main control circuit 50a, controls the sub display 3, the main display 4, the speakers 80L and 80R, etc. However, the present invention is not limited to the abovementioned configuration, and may be of such a configuration in which the main control circuit 50a directly controls the sub display 3, the main display 4, the speakers 80L and 80R, etc.

### Control Operation of Slot Machine 1

Various control operations executed in the main control circuit 50a and the sub-control circuit 171 of the slot machine 1 are described. In the description, a point awarding symbol refers to a symbol or a combination of symbols entitled to a point. For example, it refers to a REACH state, 7 DORA, RANKUP!, and the like. Symbol applicable to points addition refers to a symbol combination for which a multiplication of a payout rate determined based on a point value or another method is to be performed at payout. For example, it refers to the combination “7, 7, 7”.

FIG. 8 is a flowchart showing a routine of game execution processing of the slot machine 1.

In the game execution processing, the CPU 50 first determines whether or not the player has bet any coins (Step S10). In this processing, the CPU 50 determines whether or not the CPU 50 has received an input signal output from the 1-BET switch 59 when a player operates the 1-BET button 11, an input signal output from the 3-BET switch 60 when a player operates the 3-BET button 13, or an input signal output from the 5-BET switch 61 when a player operates the 5-BET button 14. In a case where the CPU 50 determines that the player has not bet any coins, the CPU 50 returns the processing to Step S10.

On the other hand, in a case where the CPU 50 determined in Step S10 that a coin has been bet, the CPU 50 performs processing for decrementing the credit amount stored in the RAM 52, depending on the amount of coins bet (Step S11).

Next, the CPU 50 determines whether the SPIN button 17 is activated (Step S12). In this processing, the CPU 50 determines whether or not the CPU 50 has received an input signal output from the spin switch 58 when the SPIN button 17 has been pressed. In a case where the CPU 50 determines that the SPIN button 17 is not activated, the CPU 50 returns the flow to Step S12. It should be noted that in a case where the SPIN button 17 is not activated (for example, when an indication is input that a game is terminated without the SPIN button 17 being activated), the CPU 50 cancels the decrementing results obtained in Step S11.

Next, the CPU 50 performs progressive addition (Step S13).

More specifically, the CPU 50 performs addition of a certain percentage of coins bet. The amount of credits thus added may be undisplayed (hidden progressive), and is preferentially paid out when a player wins a symbol applicable to point addition or awarding rate change, which is described later.

Next, the CPU 50 performs lottery processing (Step S14).

In the lottery processing, the CPU 50 (computation processing device) executes a lottery program stored in the RAM 52 (storage device) so as to determine the code number for each of the reels 22 when it is stationary. Thus, the symbol combination to be rearranged is determined. It should be noted that the description is made in the present embodiment regarding an arrangement in which the symbol combination to be rearranged is determined, thereby selecting one winning combination from among multiple types of winning combinations. However, an arrangement may be made according to the present invention in which one winning combination is first selected from among the multiple types of winning combinations by lottery, followed by determining the symbol combination to be rearranged based on the winning combination thus selected.

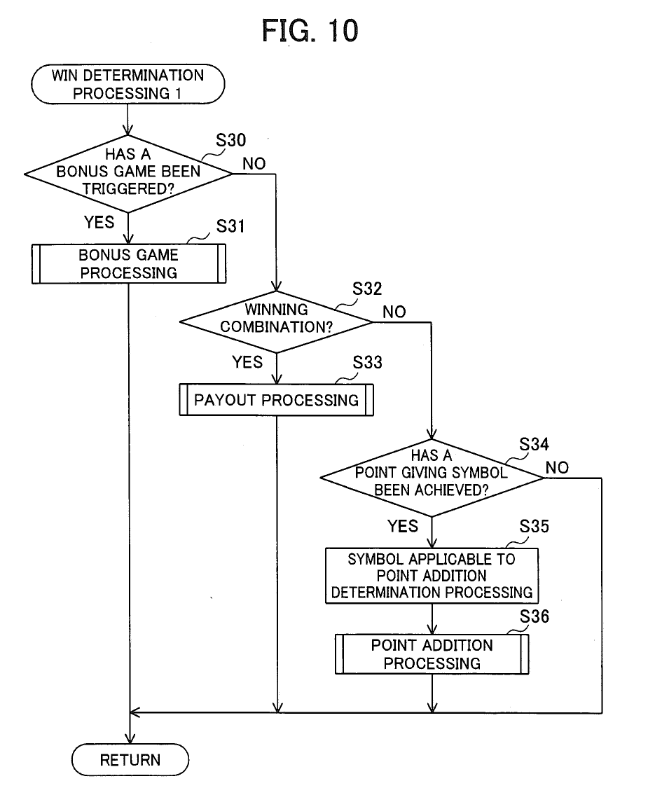

Next, the CPU 50 performs reel rotation control processing (Step S15). In this processing, after all the reels 22 start to rotate, the CPU 50 stops the rotation of each reel such that the symbol combination rearranged along the pay line matches the symbol combination that corresponds to the winning combination determined in Step S14. Next, the CPU 50 performs win determination processing (Step S16). A detailed description is provided later regarding this processing with reference to FIGS. 10, 24, 32, 37, and 41. Thereafter, the CPU 50 terminates the present processing.

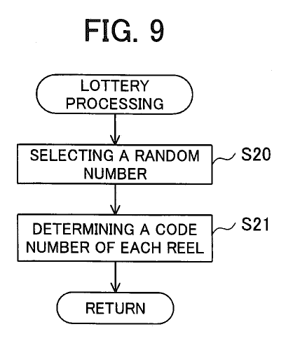

FIG. 9 is a flowchart showing a subroutine of lottery processing which is called in Step S14 of the game execution processing shown in FIG. 8, thereby executing the subroutine of lottery processing. The CPU 50 executes a lottery program stored in the RAM 52, thereby executing the lottery processing.

First, the CPU 50 selects a random number in a range of values from 0 to 255 for each of the three reels 22 by executing a random number generating program included in the lottery program (Step S20). The present embodiment describes the case of generating random numbers by way of a program (the case of using so-called software-based random numbers). In the present invention, a random number generator 55 may alternatively be provided to extract random numbers from the random number generator 55 (using so-called hardware random numbers).

Next, based on the selected three random numbers, the CPU 50 determines the code number of each reel 22 (see FIG. 5) (Step S21). Thereafter, the CPU 50 terminates the processing.

The code number selected for each reel 22 corresponds to the symbol code number of the symbol which is to be rearranged along the pay line. The CPU 50 determines the code number for each reel 22, thereby determining a winning combination. For example, in a case where the CPU 50 determines that the code numbers for the reels 22 are “00”, “00”, and “00”, it indicates that the CPU 50 has determined that a player wins the “WILD” winning combination. It should be noted that the reel rotation control processing is performed based on the reel code numbers.

FIG. 10 is a flowchart showing a subroutine of the win determination processing 1, which is called in Step S16 of the game execution processing shown in FIG. 8, whereby the subroutine of the win determination processing 1 is executed.

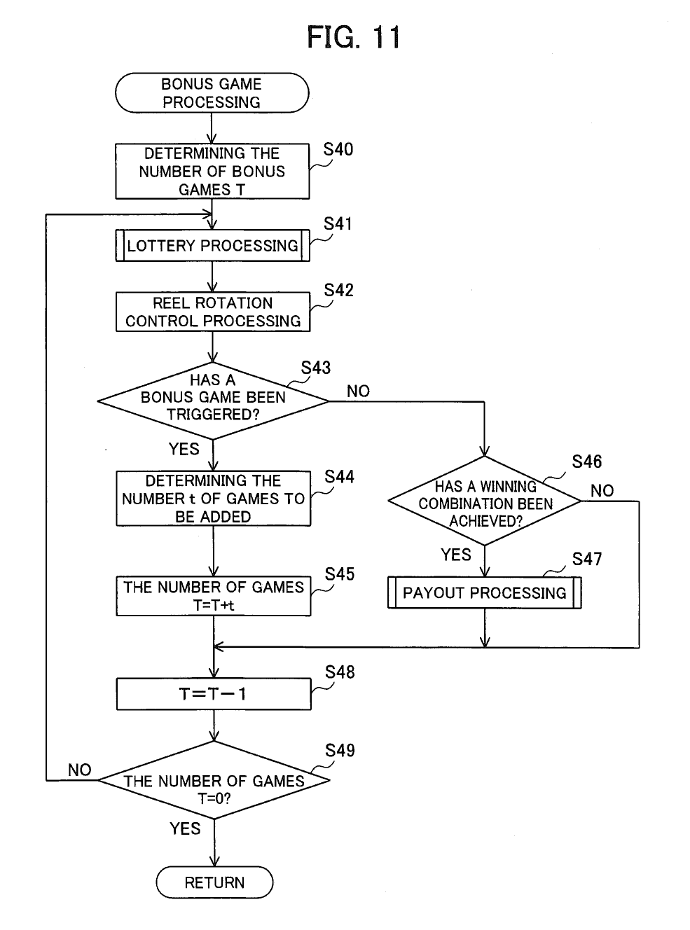

In the win determination processing 1, the CPU 50 first determines whether a bonus game has been triggered or not (Step S30). In this processing, the CPU 50 determines whether the rearranged symbol combination matches a winning combination for triggering a bonus game. In a case where the CPU 50 determines that a bonus game has been triggered, the CPU 50 calls bonus game processing (see FIG. 11 described later) (Step S31). Thereafter, the CPU 50 terminates the present processing.

On the other hand, in a case where the CPU 50 determines that a bonus game has not been triggered in Step S30, the CPU 50 determines whether a winning combination occurs or not (Step S32). In this processing, the CPU 50 determines whether the rearranged symbol combination matches a winning combination. In a case where the combination matches a winning combination, the CPU 50 calls payout processing (see FIG. 12 or 17 described later) (Step S33). Thereafter, the CPU 50 terminates the present processing.

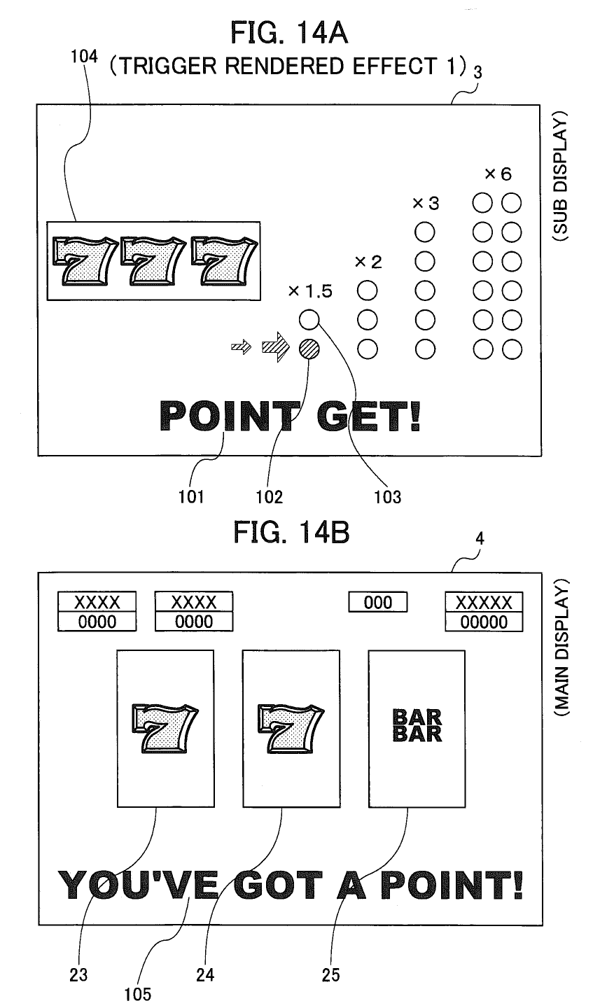

On the other hand, in a case where the CPU 50 determines that the rearranged symbol combination does not match a winning combination in Step S32, the CPU 50 then determines whether the rearranged symbol combination matches a point awarding symbol or not (Step S34). With reference to FIG. 14, for example, the point awarding symbol may be a symbol combination such as “7, 7, BAR BAR”. The CPU 50 may determine the point awarding symbol beforehand. In a case where the CPU 50 determines that the rearranged symbol combination matches a point awarding symbol, the CPU 50 performs processing for determining symbols applicable to point addition (Step S35).

In this processing, the CPU 50 determines a symbol combination (for example, “7, 7, 7” in FIG. 14) for which a multiplication of a payout rate is to be performed at payout. Next, the CPU 50 performs point addition processing (see FIG. 13 described later) (Step S36). Thereafter, the CPU 50 terminates the present processing.

On the other hand, in a case where the CPU 50 determines that the rearranged symbol combination does not match a point awarding symbol in Step S34, the CPU 50 then terminates the present processing.

FIG. 11 is a flowchart showing a subroutine of a bonus game processing, which is called in Step S31, for win determination processing 1 shown in FIG. 10, Step S81 of win determination processing 2, Step S101 of win determination processing 3, Step S121 of win determination processing 4, or Step S131 of win determination processing 5, thereby executing the subroutine of bonus game processing 1. In the bonus game processing, firstly, the CPU 50 determines a number of bonus games T based upon the random number thus obtained which is obtained by executing a random number generating program included in a lottery program stored in the RAM 52 (Step S40). The CPU 50 stores the number of bonus games T thus determined in the RAM 52.

Subsequently, the CPU 50 performs the lottery processing (Step S41) and the reel rotation control processing (Step S42). The processing in Step S41 is substantially the same as that described with reference to FIG. 9. In addition, the processing in Step S42 is substantially the same as that described with reference to FIG. 8. Since these processing steps have been described above, no description thereof follows hereafter.

Next, the CPU 50 determines whether a bonus game has been triggered or not, i.e., whether a bonus game has been triggered in display windows 23, 24, and 25 (Step S43). In a case where the CPU 50 determines that a bonus game has been triggered, it determines a repetition number t for the bonus game by lottery (Step S44). The repetition number t thus determined is added to the number of currently remaining bonus games T (Step S45). With such an arrangement, in a case where the player has won another bonus game award in a bonus game, the remaining number of the bonus games is incremented. More specifically, in a case where the player wins another bonus game award that provides 17 rounds of games during the twelfth game of an initial bonus game of 20 rounds of games, the player wins 25 (=20−12+17) rounds of bonus games.

In a case where the bonus game has not been triggered in Step S43, the CPU 50 determines whether or not the player has won a winning combination (Step S46). In a case where the CPU 50 determines that the player has won a winning combination, the CPU 50 performs payout processing (see FIG. 12 or 17 described later) (Step S47).

After the execution of the processing in Step S45 or S47, or in a case where the CPU 50 determines in Step S46 that the player has not won any winning combination (i.e., in a case where the player has lost the game), the CPU 50 reads the number of bonus games T stored in the RAM 52, and subtracts 1 from the number of bonus games T thus read. Then, the CPU 50 again stores the number of bonus games T after subtraction in the RAM 52 (Step S48).

Next, the CPU 50 determines whether or not the number of bonus games T has reached the number determined in Step S40 (Step S49). More specifically, the CPU 50 determines whether or not the number of bonus games T stored in the RAM 52 is equal to zero. When the number of bonus games is not equal to zero, i.e., in a case where the CPU 50 determines that the number of bonus games executed has not reached the number determined in Step S40, the CPU 50 returns the processing to Step S41, and repeats the aforementioned processing. On the other hand, in a case where the CPU 50 determines that the number of bonus games T is equal to zero, i.e., in a case where the CPU 50 determines that the number of bonus games executed has reached the number determined in Step S40, the CPU 50 terminates the present subroutine.

FIG. 12 is a flowchart showing a subroutine of payout processing which is called in Step S33 of win determination processing 1 shown in FIG. 10, Step S83 of win determination processing 2, Step S103 of win determination processing 3, Step S123 of win determination processing 4, Step S133 of win determination processing 5, or a subroutine of payout processing 1, which is one example of payout processing called and carried out in Step S47.

In payout processing 1, the CPU 50 first determines whether the winning is a symbol applicable to point addition or not (Step S50). In a case where the CPU 50 determines that the winning is a symbol applicable to point addition, the CPU 50 refers to the payout rate (Step S51). Next, the PCU 50 advances the processing to Step S53.

On the other hand, in Step S50, in a case where the CPU 50 determines that the winning is not a symbol applicable to point addition, the CPU 50 set the payout rate to 1 (Step S52).

Next, in Step S53, the CPU 50 pays out the amount which is equivalent to an award of the winning combination symbol multiplied by the payout rate.

FIG. 13 is a flowchart showing a subroutine of point addition processing which is called to execute in Step S36 of win determination processing shown in FIG. 10.

In the point addition processing, the CPU 50 first performs a summation of points (Step S60). Next, the CPU 50 determines whether the points have exceeded a threshold or not (Step S61). In a case where the CPU 50 determines that the points have not exceeded the threshold, the CPU 50 terminates the present processing. On the other hand, in a case where the CPU 50 determines that the points have exceeded the threshold, the CPU 50 performs processing for updating the payout rate (Step S62). Thereafter, the CPU 50 terminates the present processing.

### Trigger Rendered Effect and WIN Rendered Effect

A trigger rendered effect refers to a rendered effect of point addition processing by a point awarding symbol and a WIN rendered effect refers to a rendered effect of payout processing by a symbol applicable to point addition, which are described in the abovementioned flowchart (Steps S33 and S34 to S36 in FIG. 10). Regarding the abovementioned rendered effects, an example of images displayed for a trigger rendered effect 1 and its variations, trigger rendered effects 2 and 3 is described with the drawings. In addition, an example of images displayed for a WIN rendered effect 1 in the trigger rendered effects 1 and 2 and a WIN rendered effect 2 in the trigger rendered effect 3 is described with reference to the drawings.

### Trigger Rendered Effect 1

FIGS. 14A and 14B are an example of images representing a trigger rendered effect 1 displayed on the main display 14 and the sub display 3. In the trigger rendered effect 1, a payout rate is determined based on points which are added when a rearranged symbol combination is in the REACH state. An image of the trigger rendered effect 1 shown in FIGS. 14A and 14B show that the rearranged symbol combination is in the REACH state in relation to a “7” combination, which is a situation indicating that the point is equivalent to 1 and the payout rate is 1.5. Even in a case where a player loses a game, the point is accumulated, thereby preventing a situation in which a player loses interest in the amusement service.

FIG. 14A shows an example of an image of the trigger rendered effect 1 displayed on the sub display 3. The image shown in FIG. 14A indicates an obtained point value to execute a special program by accumulating the point value, a payout rate, and a symbol combination of payout. The point accumulation is indicated by oblique lines in the arrows 401 and 402. The obtained point to execute the special program is represented with a circle with oblique lines 102 in the trigger rendered effect 1 (a display type for showing a required number). The payout rate is represented with “×1.5”, “×2”, “×3”, and “×6”. The symbol combination of payout is represented as “7, 7, 7” as indicated by a numeral 104. In addition, a point is represented with an open circle 103. For example, the image shown in FIG. 14A indicates that the rate is 1.5 if the point is not more than 2, the rate is 2 if the point is 3 to 5, the rate is 3 if the point is 6 to 10, and the rate is 6 if the point is equal to or greater than 11. In other words, the image of the trigger rendered effect 1 shown in FIG. 14A indicates that the amount of normal payout multiplied by the rate 1.5 is paid out in a case where a symbol combination is “7, 7, 7”. Also in this image, the message “POINT GET!” 101 represents that a player obtains a point.

FIG. 14B shows an example of an image of the trigger rendered effect 1 displayed on the main display 4. The image shown in FIG. 14B illustrates symbols rearranged, and then the combination “7, 7, BARBAR”, which is in the REACH state in relation to the combination “7, 7, 7”, is displayed in the left display window 23, the center display window 24, and the right display window 25. A message “YOU'VE GOT A POINT!” 105 represents that a player has obtained a point.

### WIN Rendered Effect 1

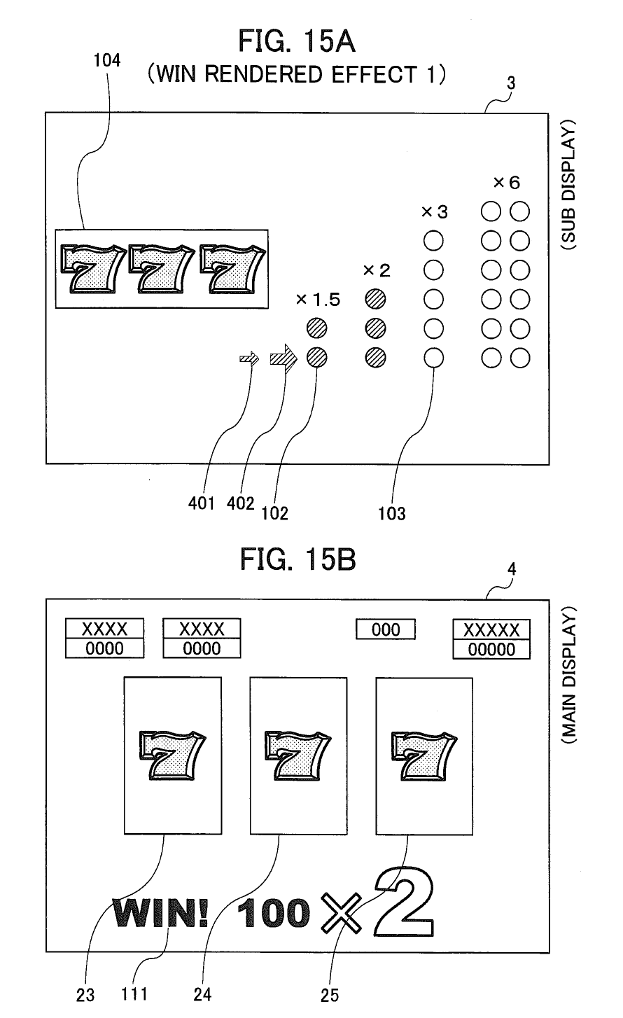

FIGS. 15A and 15B show an example of images of the WIN rendered effect 1 displayed on the main display 4 and the sub display 3. In the WIN rendered effect, a certain amount is paid out based on a rate according to point addition in a case where a rearranged symbol combination is equivalent to symbols applicable to point addition. The images of the WIN rendered effect 1 shown in FIGS. 15A and 15B indicate that since the rearranged symbol combination is “7, 7, 7”, a certain amount is paid out based on a rate according to point addition.

FIG. 15A shows an example of an image of the WIN rendered effect 1 displayed on the sub display 3. The image represents 5 points obtained by a player, as indicated by circles with oblique lines 102. In addition, “7, 7, 7” 104 and “×2” indicate that a player obtains double amount of normal payout in a case where a symbol combination is “7, 7, 7”.

FIG. 15B shows an example of an image of the WIN rendered effect 1 displayed on the main display 4. The image represents a rearrangement of symbols and the resulting combination “7, 7, 7” displayed in the left display window 23, the center display window 24, and the right display window 25. A message “WIN! 100×2” 111 indicates that a player obtains double the normal payout of 100 credits when the combination is “7, 7, 7”.

### Trigger Rendered Effect 2

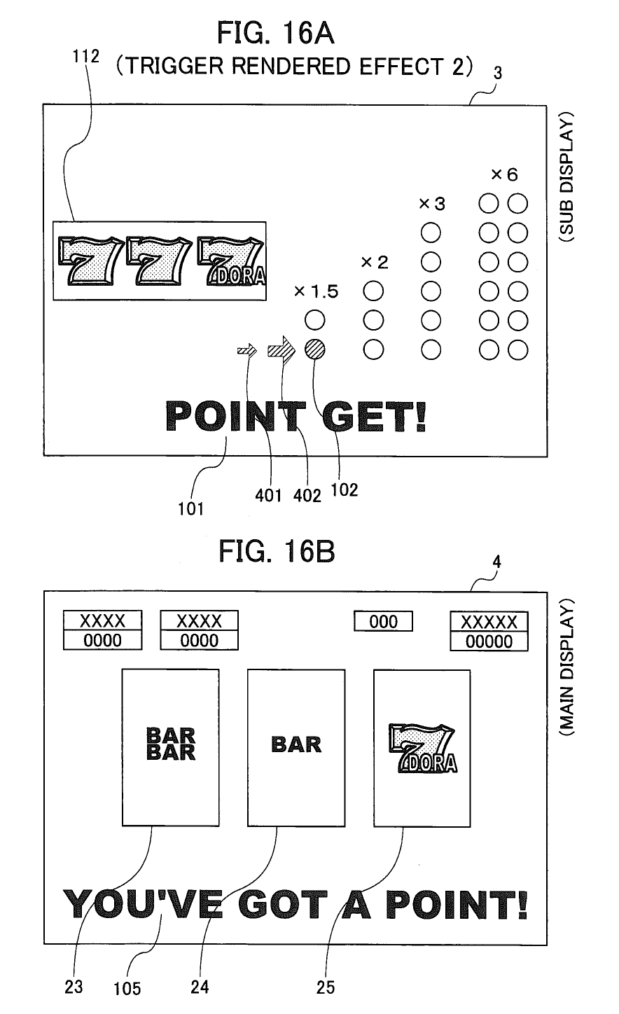

In the trigger rendered effect 1, a payout rate is determined based on points which are added when a rearranged symbol combination is in the REACH state. On the other hand, in the trigger rendered effect 2, a payout rate is determined based on points added when one of the rearranged symbols has a DORA symbol. An embodiment regarding the foregoing is described with reference to FIG. 16.

FIGS. 16A and 16B are an example of images representing a trigger rendered effect 2 displayed on the main display 14 and the sub display 3. The images of the trigger rendered effect 2 shown in FIGS. 16A and 16B show that points are added in a case where one of the rearranged symbols is “7 DORA”.

FIG. 16A is an example of an image representing the trigger rendered effect 2 displayed on the sub display 3. An image shown in FIG. 16 indicates that the amount of a normal payout multiplied by the rate 1.5 is paid out in a case where a symbol combination is “7, 7, 7 DORA”.

FIG. 16B shows an example of an image of the trigger rendered effect 2 displayed on the main display 4. The image represents a rearrangement of symbols and the resulting combination “BAR BAR, BAR, 7 DORA”, which includes a DORA symbol, displayed in the left display window 23, the center display window 24, and the right display window 25.

In addition, as a variation for awarding points, such an arrangement may alternatively be made in which when a symbol with a DORA symbol is displayed, a lottery is performed to determine whether points are given or not, as well as an arrangement in which points are added, whenever a symbol with a DORA symbol is displayed.

### Trigger Rendered Effect 3 (HALF WILD)

In the trigger rendered effect 1, a payout rate is determined based on points which are added when a rearranged symbol combination is in the REACH state. On the other hand, in the trigger rendered effect 3, a payout rate is determined based on points which are added when one of the rearranged symbols is a specified symbol (“HALF WILD”). An embodiment regarding the foregoing is described with reference to FIGS. 17 to 19.

### Flowchart of Payout Processing 2 (HALF WILD)

FIG. 17 is a flowchart showing a subroutine of payout processing 2 as an example of payout processing which is called to execute in Step S33 of win determination processing shown in FIG. 10, Step S83 of win determination processing 2, Step S103 of win determination processing 3, Step S123 of win determination processing 4, Step S131 of win determination processing 5 or Step S47 of bonus game processing.

In payout processing 2, the CPU 50 first determines whether the winning includes a symbol applicable to point addition or not (Step S70). In a case where the CPU 50 determines that the winning includes a symbol applicable to point addition, the CPU 50 refers to a payout rate (Step S71). Next, the CPU 50 advances the processing to Step S73.

On the other hand, in Step S70, in a case where the CPU 50 determines that the winning does not include a symbol applicable to point addition, the CPU 50 sets the payout rate to 1 (Step S72).

Next, in Step S73, the CPU 50 determines whether the rearranged symbol combination includes a HALF WILD symbol or not. In a case where the CPU 50 determines that the rearranged symbol combination includes a HALF WILD symbol, the CPU 50 pays out half of the amount of an award for a winning symbol multiplied by a payout rate (Step S74). Thereafter, the CPU 50 terminates the present processing.

On the other hand, in Step S73, in a case where the CPU 50 determines that a HALF WILD symbol is not included, the CPU 50 pays out an amount which is equivalent to the award for the winning symbol multiplied by the payout rate (Step S75). Thereafter, the CPU 50 terminates the present processing.

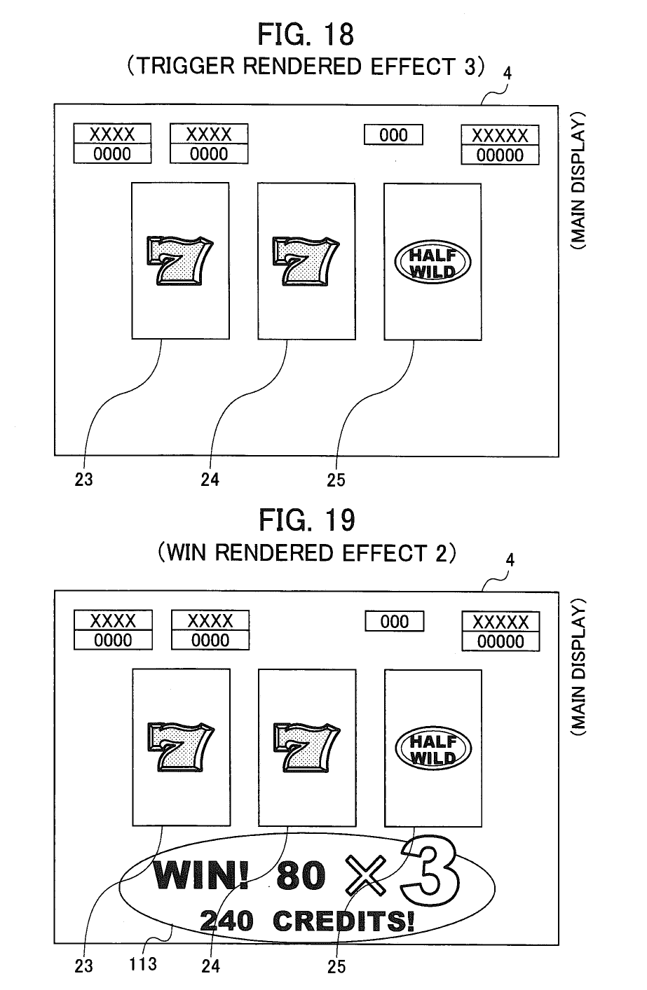

FIG. 18 is an example of an image representing a trigger rendered effect 3 displayed on the main display 14. The image represents a rearrangement of symbols and the resulting combination “7, 7, HALF WILD” displayed in the left display window 23, the center display window 24, and the right display window 25. Since one of the rearranged symbols is “HALF WILD”, it shows that points are added.

### WIN Rendered Effect 2

FIG. 19 is an example of an image representing a WIN rendered effect 2 displayed on the main display 14. The image represents a rearrangement of symbols and the resulting combination “7, 7, HALF WILD” displayed in the left display window 23, the center display window 24, and the right display window 25. Since a winning of HALF WILD occurs, the image represents that a certain amount multiplied by the payout rate based on points is paid out. A message “WIN! 80×3 240 CREDITS!” 113 indicates the payout of 240 credits that are equivalent to half the amount (160 credits) multiplied by 3 for a case where the payout rate is 3 based on the currently obtained points and normal payout of the combination “7, 7, 7” is 160 credits.

### Regarding Variations of Points Display

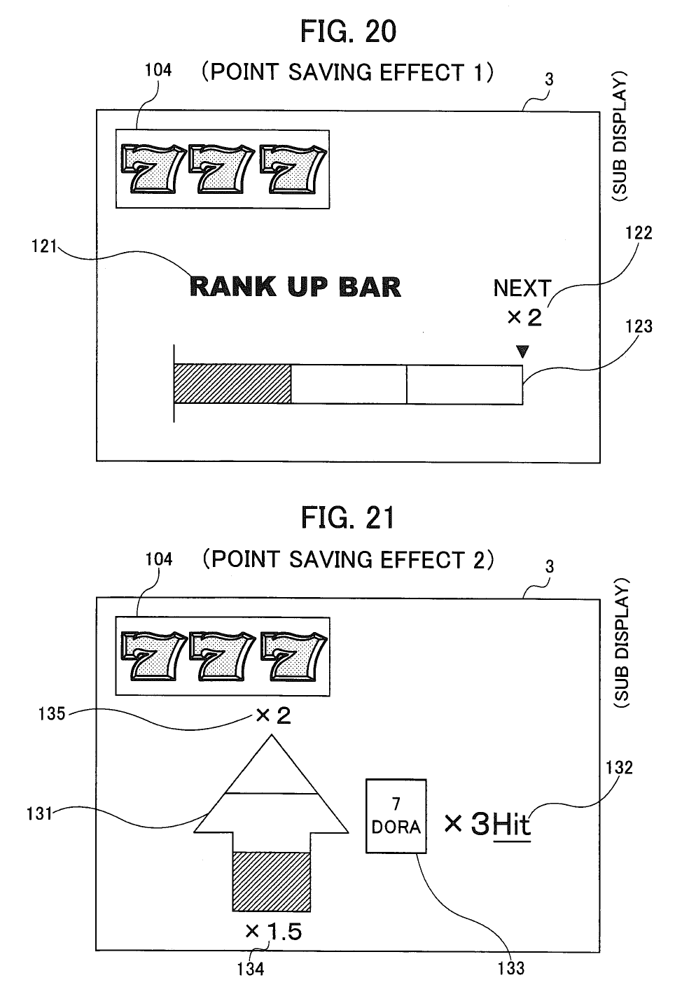

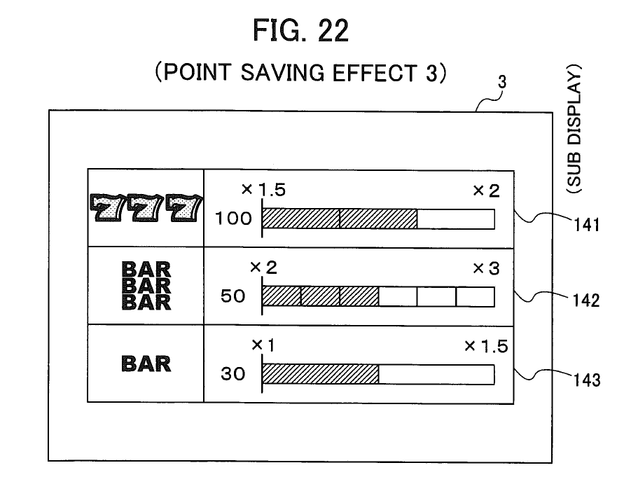

An image of the trigger rendered effect indicates obtained points, a payout rate, and a symbol combination of a payout. As an example of an image, a display type for showing required points to upgrade the payout rate is shown in FIG. 14. Here, other display types are described. Examples for the other display types are as follows: a point saving effect 1, which does not show at which points a payout rate is upgraded (see FIG. 20 described later); a point saving effect 2, which does not show information as to current points that a player has obtained (see FIG. 21 described later); and a point saving effect 3, which accumulates points for each winning combination (see FIG. 22 described later). Each of these types can be displayed in combination with a trigger rendered effect.

Details of each display type are described below with reference to the drawings.

### Points Saving Effect 1

FIG. 20 is an example of an image displaying the obtained points on the sub display 3. This display type (gauge type) does not show any specific information such as current points that a player has obtained, points by which a payout rate is upgraded, and the like. In the image shown in FIG. 20, a message “RANK UP BAR” 121 indicates that a gauge 123 represents progress of upgrading to the next level, and “NEXT×2” 122 indicates that a payout rate becomes double by an upgrade to the next level through incrementing of points. More specifically, this example shows that a certain amount is paid out based on a rate according to point addition, and a payout rate becomes double as a result of upgrading for a case where the rearranged symbol combination is “7, 7, 7”.

### Points Saving Effect 2

FIG. 21 is an example of an image displaying the obtained point on the sub display 3. This display type (a numeral value display type) does not show any information as to what points a player possesses. An arrow 131 divided into three pieces represents a current payout rate and a probability that the current payout rate is upgraded to the next level of payout rate if a predetermined condition is fulfilled. “7 DORA” 133 represents a symbol applicable to point addition. “×3 Hit” 132 represents that the current payout rate is upgraded to the next level of payout rate if the number of appearances of a symbol applicable to point giving reaches three times. That is, the present example represents that the current payout rate is 1.5 and the payout rate becomes double if the number of appearances of “7 DORA” reaches three times. In a case where a payout rate is changed, for example, the displayed “×1.5” 134 changes to “×2” and the displayed “×2” 135 changes to “×3”.

### Points Saving Effect 3

FIG. 22 is an example of an image displaying the obtained points on the sub display 3. This display includes a gauge that is divided to show the points required for each winning combination. When points are accumulated, a gauge applicable to the next upgrading appears on the display. In the rendered image shown in FIG. 22, an image 141 indicates that the payout is 100 credits in a case where a rearranged symbol combination is “7, 7, 7”. This example shows that the current payout rate is 1.5, three points are required for upgrading, and the current points obtained a player is two. Similarly, an image 142 indicates that the payout is 50 credits in a case where a rearranged symbol combination is “3 BAR, 3 BAR, 3 BAR”. This example shows that the current payout rate is 2, six points are required for upgrading, and the current points obtained by a player is three. Furthermore, an image 143 indicates that the payout is 30 credits in a case where a rearranged symbol combination is “BAR, BAR, BAR”. This example shows that the current payout rate is 1, two points are required for upgrading, and the current points obtained by a player is one.

In an aspect of the point saving effect 3, for example, the CPU 50 may add points for the combination “7-7-7” (the image 141) in a case where a rearranged symbol combination is “7, 7, BAR”, and may add points for the combination “3BAR-3BAR-3BAR” in a case where a rearranged symbol combination is “3BAR-3BAR-7”. That is, a symbol combination entitled to receiving points may be different depending on each winning combination.

### Variation 2: RANK UP!

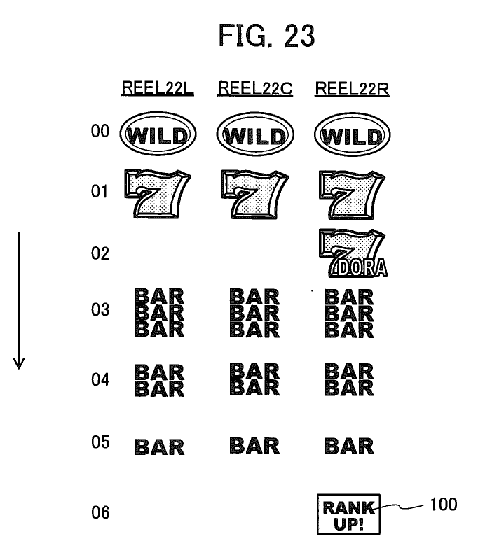

A variation that provides a symbol “RANKUP!” is described here. In a case where the symbol “RANK UP!” appears in a rearrangement, points are added. When the accumulated points exceed a threshold, a symbol applicable to point addition is updated. This example is described with reference to FIGS. 23 to 28.

FIG. 23 shows symbols arranged on the reels 22L, 22C, and 22R, and code numbers. FIG. 23 shows one example of a symbol line that includes seven pieces of symbols, a plurality types of symbols, which are shown on each reel 22L, 22C, and 22R have been arranged. Symbol lines with a plurality of types of symbols in FIG. 23 are similar to those of FIG. 5 except for the “RANK UP!” symbol 100.

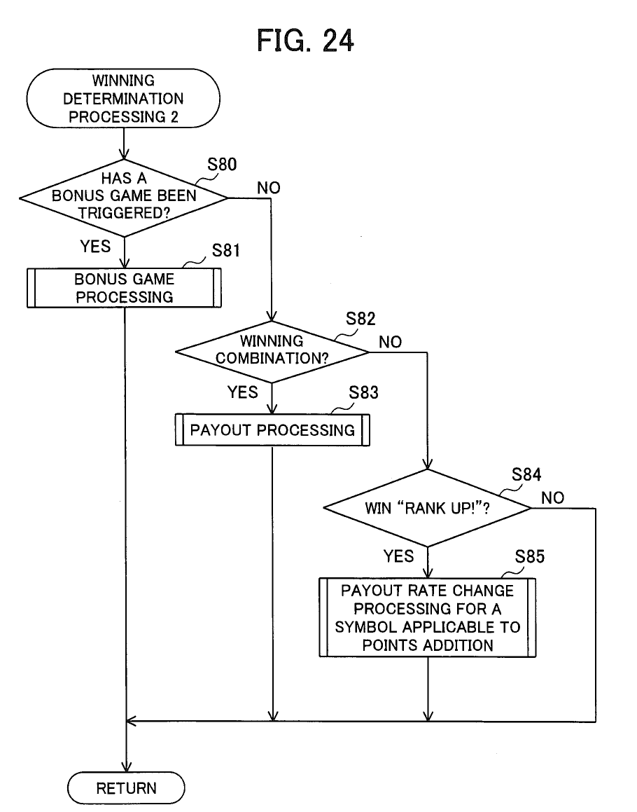

FIG. 24 is a flowchart showing a subroutine of win determination processing 2 with regards to “RANK UP!”. Win determination processing 2 is called and executed in Step S16 of game execution processing shown in FIG. 8 in a case where the “RANK UP!” symbol 100 occurs among the plurality of types of symbols shown on the reels 22L, 22C, and 22R.

In win determination processing 2, the CPU 50 first determines whether a bonus game has been triggered or not (Step S8). In the processing, the CPU 50 determines whether the rearranged symbol combination matches a winning combination for triggering a bonus game. In a case where the CPU 50 determines that a bonus game has been triggered, the CPU 50 calls bonus game processing (see FIG. 11) (Step S81), and then terminates the present processing.

On the other hand, in a case where the CPU 50 determines that the bonus game has not been triggered, the CPU 50 determines whether or not a player has won any award (Step S82). In this processing, the CPU 50 determines whether the rearranged symbol combination matches a winning combination. In a case where the rearranged symbol combination matches a winning combination, the CPU 50 calls payout processing (see FIG. 12 or 17) (Step S83) and terminates the present processing.

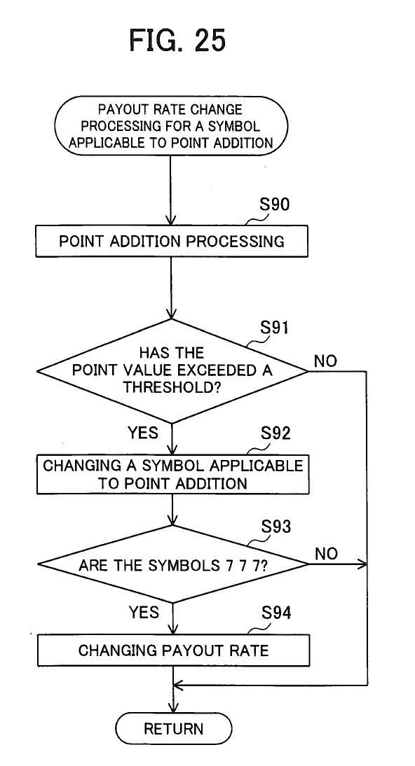

On the other hand, in a case where the CPU 50 determines that the rearranged symbol combination does not match a winning combination, the CPU 50 then determines whether the rearranged symbol combination achieves “RANK UP!” or not (Step S84). In this processing, the CPU 50 determines whether the rearranged symbols include a “RANK UP!” symbol or not. In a case where the CPU 50 determines that the rearranged symbol includes a “RANK UP!”, the CPU 50 performs payout rate change processing for a symbol applicable to point addition (see FIG. 25 described later) (Step S85). Thereafter, the CPU 50 terminates the present processing.

On the other hand, in a case where the CPU 50 determines that the rearranged symbol combination does not achieve “RANK UP!” in Step S84, the CPU 50 then terminates the present processing.

FIG. 25 is a flowchart showing a subroutine of payout rate change processing for a symbol applicable to point addition, which is called to execute in Step S85 of win determination processing 2 as shown in FIG. 24.

In payout rate change processing for a symbol applicable to point addition, the CPU 50 first performs point addition processing (Step S90). Next, the CPU 50 determines whether point value has exceeded a threshold or not (Step S91). In a case where the CPU 50 determines that the point value has not exceeded the threshold, the CPU 50 terminates the present processing.

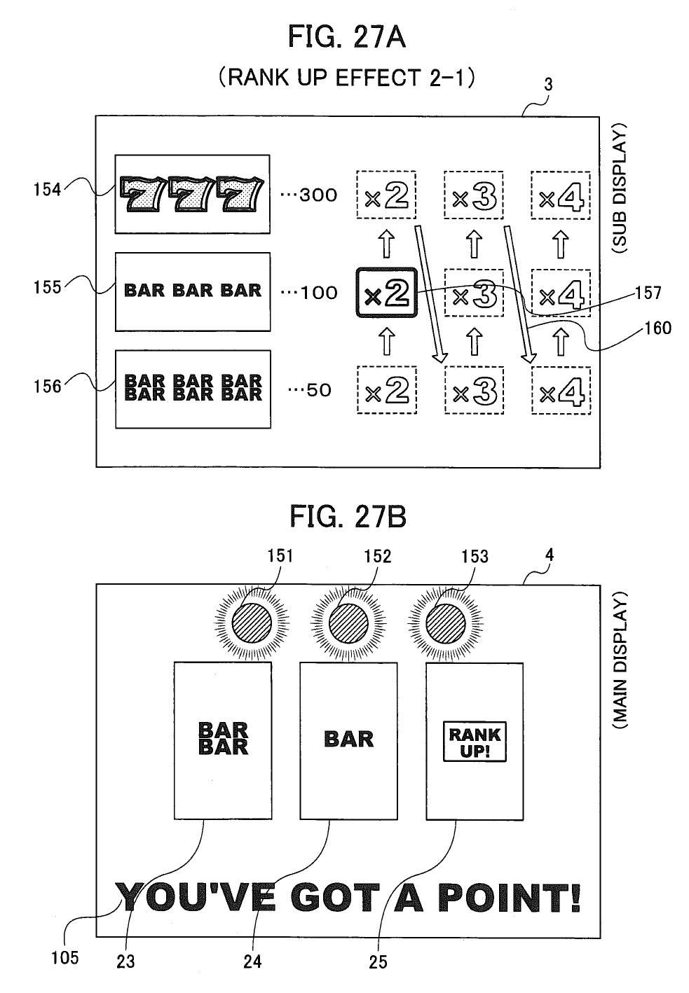

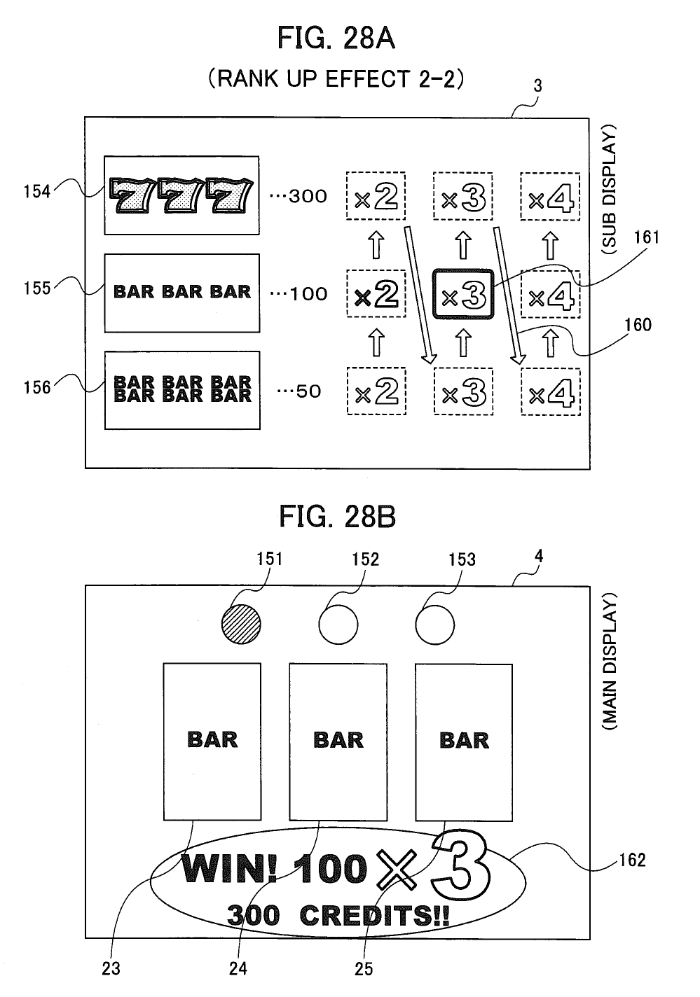

On the other hand, in a case where the CPU 50 determines that the point value has exceeded the threshold in Step S91, the CPU 50 changes a symbol applicable to point addition (Step S92) (see FIG. 27 described later). Next, the CPU 50 determines whether the symbol combination is “7, 7, 7” or not (Step S93). In a case where the CPU 50 determines that the symbol combination is not “7, 7, 7”, the CPU 50 terminates the present processing. On the other hand, in a case where the CPU 50 determines that the symbol combination is “7, 7, 7”, the CPU 50 changes the payout rate (Step S94) (see FIG. 28 described later). Thereafter, the CPU 50 terminates the present processing.

### RANK UP Effect 1

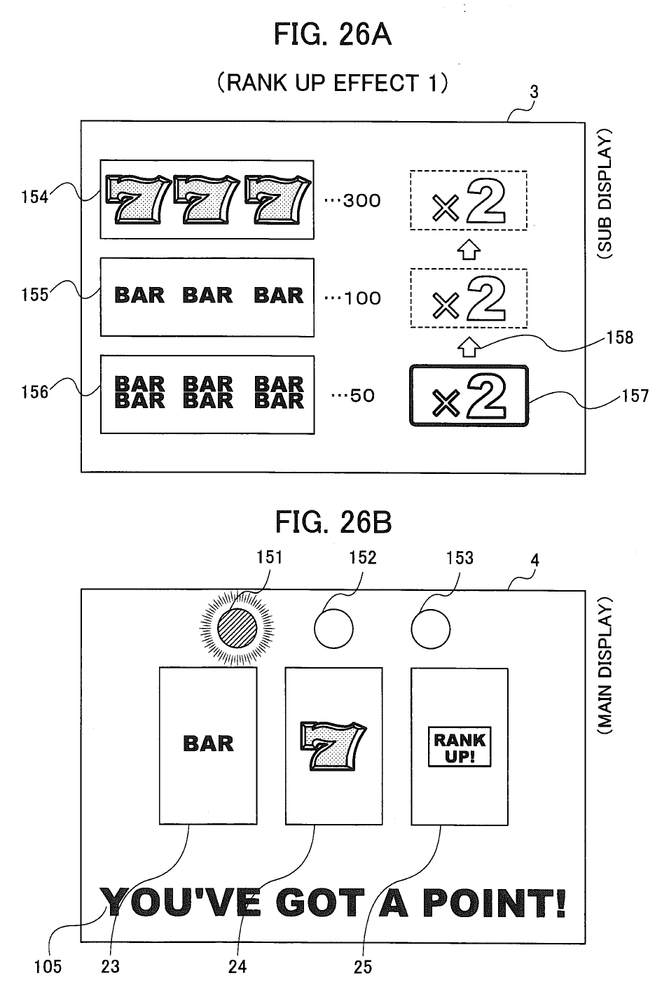

FIGS. 26A and 26B are one example of images showing the RANK UP effect 1 displayed on the main display 4 and the sub display 3. An image of the RANK UP effect 1 shown in FIGS. 26A and 26B indicate that points are added in a case where a rearranged symbol includes a “RANK UP!” symbol and that a symbol applicable to point addition is updated in a case where the point value thus added exceeds a threshold.

FIG. 26A is an example of an image of the RANK UP effect 1 displayed on the sub display 3. In the image shown in FIG. 26A, “BARBAR BARBAR BARBAR—50”, as indicated by a numeral 156, represents that an amount of payout is 50 credits in a case where a rearranged symbol combination is “BARBAR”. Similarly, “BAR BAR BAR—100”, as indicated by a numeral 155, represents that an amount of payout is 100 credits in a case where a rearranged symbol combination is “BAR”. In addition, “7 7 7—300”, as indicated by a numeral 154, represents that an amount of payout is 300 credits in a case where a rearranged symbol combination is “7, 7, 7”. Furthermore, “×2” represents that a payout rate is double. In addition, an arrow 158 indicates that a symbol applicable to point addition is updated in a case where a game is executed, a “RANK UP!” symbol appears following a rearrangement of symbols, and the point value thus added exceeds a predetermined threshold.

In the present example identified by a bold line 157 enclosing “×2”, a symbol applicable to point addition is 2BAR (BARBAR), and the payout rate is double.

FIG. 26B is an example of an image of the RANK UP effect 1 displayed on the main display 4. In the image shown in FIG. 26B, symbols are rearranged and the combination “BAR, 7, RANK UP!” is displayed on the left display window 23, the center display window 24, and the right display window 25, respectively. Marks 151, 152, and 153 represent that a “RANK UP!” symbol has appeared and points have been added. The present example represents that the mark 151 is turned on when the “RANK UP!” symbol appears once. In a case where the “RANK UP!” symbol appears three times, the point value thus added exceeds a threshold. Then, a symbol applicable to point addition is changed from 2BAR (BARBAR) to “BAR BAR BAR—100”.

### RANK UP Effect 2

FIGS. 27A and 27B are an example of images showing the RANK UP effect 2 displayed on the main display 4 and the sub display 3. FIGS. 27A and 27B illustrates updating of a payout rate for a case where points accumulated based on the number of appearances of the “RANK UP!” symbol exceeds a threshold, and one round of updating of symbols applicable to point addition is completed.

FIG. 27A is an example of an image of the RANK UP effect 2 displayed on the sub display 3. In the image shown in FIG. 27A, “BARBAR BARBAR BARBAR—50” 156, “×2”, and the like are similar to those of FIG. 26A. An arrow 160 indicates that the payout rate is upgraded to triple for a case when the following conditions are met: a game is executed, the “RANK UP!” symbol appears following a rearrangement of symbols, the point value added exceeds a predetermined threshold, and a symbol applicable to point addition is updated from “7, 7, 7—300 ×2” to the next one. Similarly, the arrow 160 indicates the payout rate is further upgraded to quadruple when another round of updating of the symbol applicable to point addition occurs.

FIG. 27B is an example of an image of the RANK UP effect 2 displayed on the main display 4. The image shows a rearrangement of symbols and the resulting combination “BARBAR, BAR, RANK UP!” displayed in the left display window 23, the center display window 24, and the right display window 25, respectively. Since the points thus added are three, all the marks 151, 152, and 153 are turned on. The sub display 3 shows that the symbol applicable to point addition is changed to “BAR BAR BAR—100”.

FIGS. 28A and 28B are an example of images of the RANK UP effect 2 displayed on the main display 4 and the sub display 3 after a transition of game state shown in FIGS. 27A and 28B.

FIG. 28A is an example of an image of the RANK UP effect 2 displayed on the sub display 3. In the image shown in FIG. 28A, “×3” with a bold line 161 indicates that an award is 100 credits and its payout rate is triple in a case where a rearranged symbol combination forms “BAR BAR BAR”.

FIG. 28B is an example of an image of the RANK UP effect 2 displayed on the main display 4. In the image shown in FIG. 28B, symbols are rearranged and the combination “BAR, BAR, BAR” is displayed in the left display window 23, the center display window 24, and the right display window 25, respectively. Since the combination “BAR, BAR, BAR” is achieved, the message “WIN! 100×3 300 CREDITS!!” 162 is displayed, which indicates that the payout is 300 credits.

### Variation 3: WHEEL

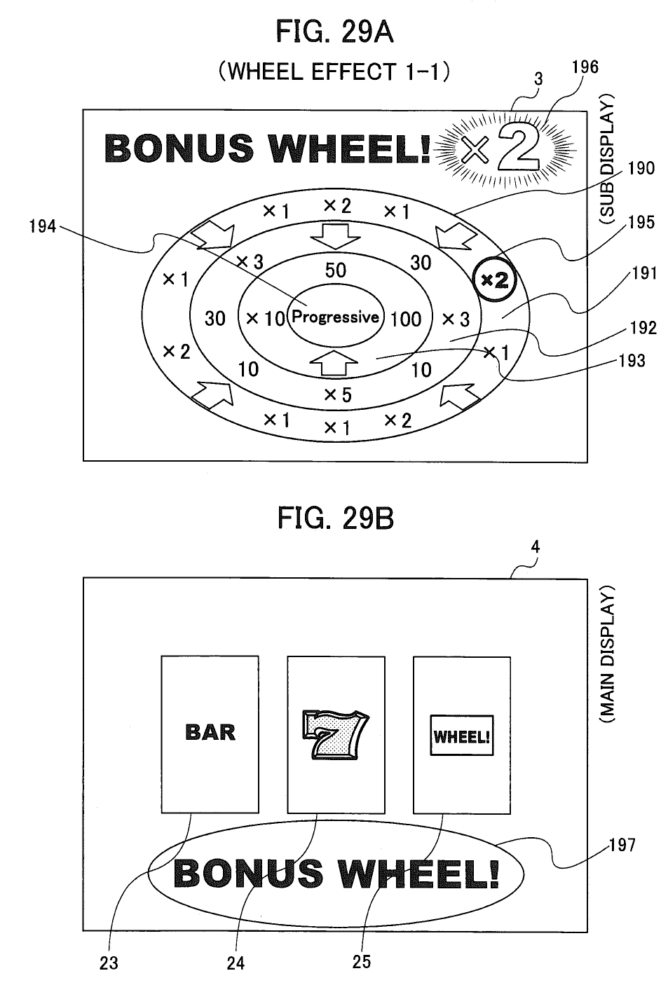

A variation that provides a symbol “WHEEL” is described here. In a case where a “WHEEL” symbol is arranged, a payout rate or an award is determined by lottery. A WHEEL winning combination is determined here. WHEEL winning combination refers to a symbol combination to which an award determined by lottery is provided along with a payout rate, which is also determined by lottery. This example is described with reference to FIGS. 29 to 31.

### WHEEL Effect 1

FIGS. 29A and 29B are an example of images of the WHEEL effect 1 displayed on the main display 4 and the sub display 3. As shown in FIGS. 29A and 29B, a payout rate or an award is selected for a case where a “WHEEL!” symbol is rearranged.

FIG. 29A is an example of an image of the WHEEL effect 1 displayed on the sub display 3. The image shown in FIG. 29A shows that a payout rate or an award on four elliptical sections 190 (hereinafter referred to as “layers 190”) is selected based on a result of a lottery. When a “WHEEL” symbol appears, a payout rate or an award on a first layer 191 is to be selected by a lottery. Based on the result of the lottery, a payout rate such as “×2” or an arrow oriented to a second layer is selected. In this example, “×2” is selected, and a circle with a bold line 195 and the message “BONUS WHEEL!×2” 196 indicate that the payout rate is double. The WHEEL winning combination may be determined by lottery when a “WHEEL!” symbol has appeared or may alternatively be determined in advance.

For example, the CPU 50 determines any one of a payout rate and an arrow on the first layer by lottery of random numbers. In a case where an arrow is selected based on the result of the lottery, a game shifts to the second layer. Subsequently, the CPU 50 determines any one of a payout rate, an award, and an arrow on the second layer. In a case where the CPU 50 selects “30” indicating an award, the CPU 50 provides a normal award plus 30 credits every time a WHEEL winning combination (7-7-WILD) is formed in a subsequent game. In addition, for example, in a case where the CPU 50 selects “×2”, the CPU 50 provides double the amount of a normal payout every time a WHEEL winning combination (7-7-WILD) is formed in a subsequent game. In addition, every time a “WHEEL!” symbol appears and the WHEEL effect is performed, the CPU 50 changes a status of payout rate such as “×2”, “×3”, and “30”. Furthermore, in a case where a game reaches a fourth layer by the WHEEL effect, the CPU 50 provides a progressive award. In addition, regarding a way of lottery on the WHEEL effect, a symbol may be determined for each layer or may be determined for all the layers (the first layer to the fourth layer) based on a result of a single lottery.

FIG. 29B is an example of an image of the WHEEL effect 1 displayed on the main display 4. The image indicates a rearrangement of symbols and the resulting combination “BAR, 7, WHEEL!” displayed in the left display window 23, the central display window, and the right display window, respectively. The message “BONUS WHEEL!” 197 indicates that a rendered effect starts as a result of an appearance of “WHEEL!”.

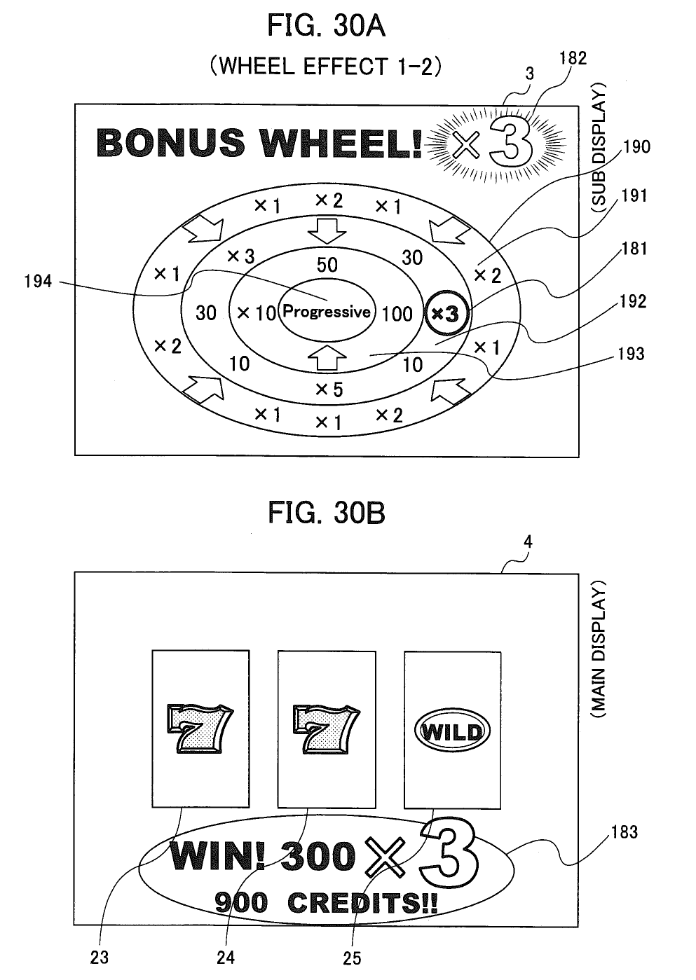

FIGS. 30A and 30B are an example of images of the WHEEL effect 1 displayed on the main display 4 and the sub display 3 in a case where a game has been executed and advanced from FIG. 29.

FIG. 30A is an example of an image of the WHEEL effect 1 displayed on the sub display 3 in a case where a rearranged combination matches a WHEEL winning combination. In the image shown in FIG. 30A, a circle with a bold line 181 and the message “BONUS WHEEL!×3” indicate that a payout rate is triple selected by a lottery on the second layer 192.

FIG. 30B is an example of an image of the WHEEL effect 1 displayed on the main display 4. The image indicates a rearrangement of symbols and the resulting combination “7, 7, WILD” forming a WHEEL winning combination displayed in the left display window 23, the center display window 24, and the right display window 25. The message “WIN! 300×3 900 CREDITS!!” 183 indicates that 900 credits are paid out for the rearranged symbol forming a WHEEL winning combination.

### WHEEL Effect 2

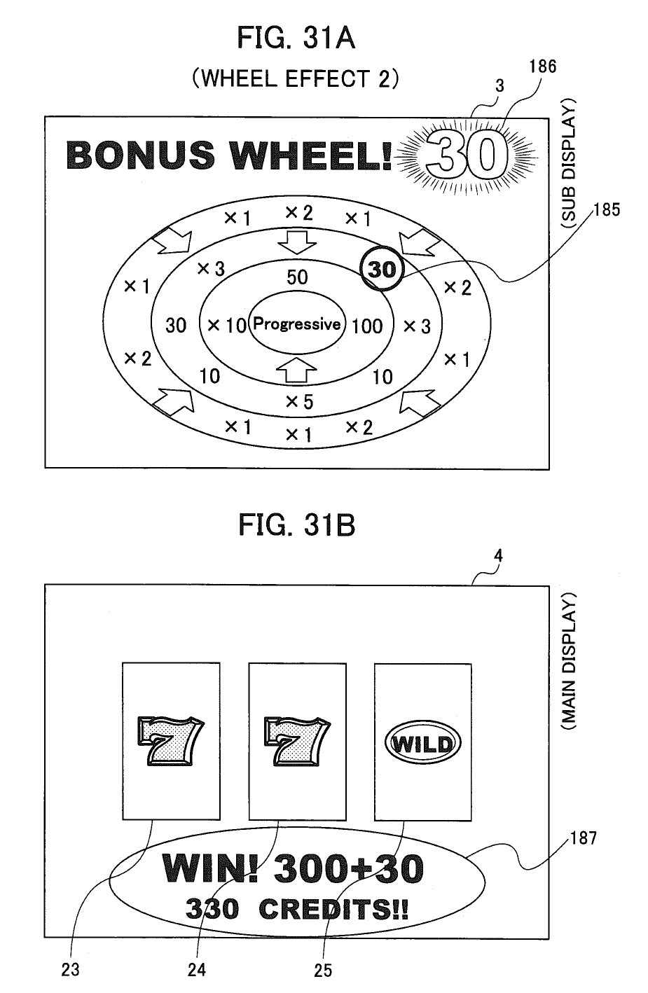

FIGS. 31A and 31B are an example of images showing the WHEEL effect 2 displayed on the main display 4 and the sub display 3 in a case where a rearranged combination matches a WHEEL winning combination. The image of the WHEEL effect 2 shown in FIG. 31A indicates that an arrow orienting to the second layer and “30” on the second layer are selected by a lottery of random numbers.

FIG. 31A is an example of an image showing the WHEEL effect 2 displayed on the sub display 3. In the image shown in FIG. 31A, a circle with a bold line 185 and the message “BONUS WHEEL! 30” 186 indicate that a payout as a fixed award is 30 credits based on a lottery on the second layer 192. Suppose that although “×2” has been selected as a payout rate as described above, a player wins an arrow orienting to the second layer and an award “30” by a lottery of random numbers. When the player achieves a WHEEL winning combination, she earns a total of 330 credits, which includes a normal award of 300 and an additional award of 30. That is, the payout rate “×2” is cancelled and a predetermined award “30” is paid out instead. Then the CPU 50 terminates the WHEEL effect.

FIG. 31B is an example of an image of WHEEL effect 2 displayed on the main display 4. The image indicates a rearrangement of symbols and the resulting symbol combination “7, 7, WILD”, which matches a WHEEL winning combination, displayed in the left display window 23, the center display window 24, and the right display window 25, respectively. The message “WIN! 300+30 330 CREDITS!!” indicates that 330 credits are paid out for the rearranged symbols matching a WHEEL winning combination.

### WILD

Here, a case is described in which a “WILD” symbol is rearranged. The “WILD” symbol can represent any symbol in a rearranged combination. For example, in a case where a rearranged symbol combination is “BAR BAR WILD”, this combination is equivalent to a combination “BAR BAR BAR”.

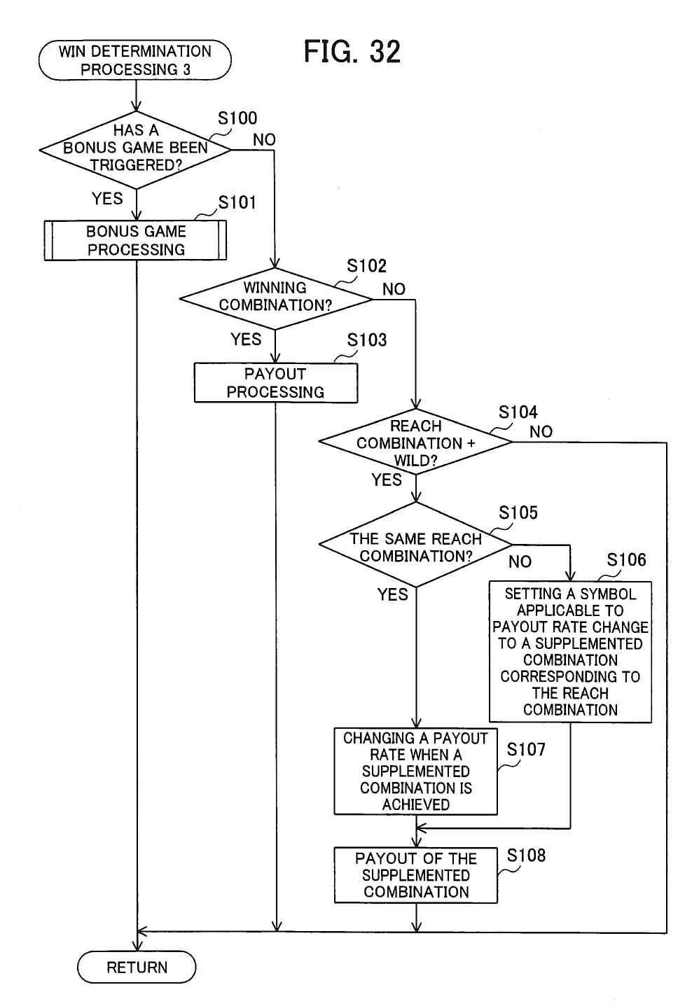

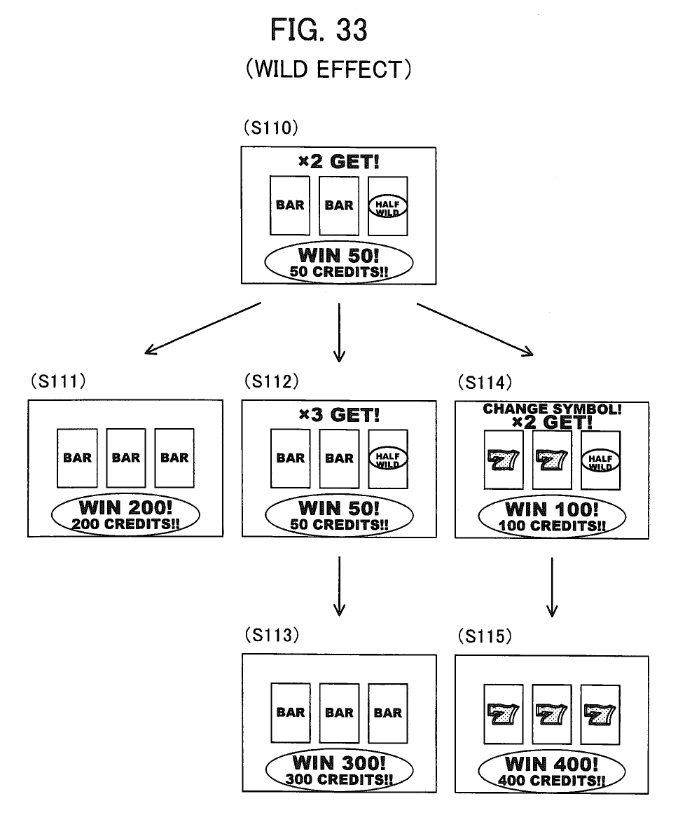

The equivalent symbol combination in this case (“BAR BAR BAR”), in which one “BAR” symbol is represented by a “WILD” symbol, is called an “supplemented combination”. The wild effect is described with reference to FIGS. 32 and 33. In addition, since the payout rate is not determined based on added points in the following embodiments, explanations are made using the term “a symbol applicable to payout rate change” instead of using “a symbol applicable to point addition”.

FIG. 32 is a flowchart showing a subroutine of the win determination processing 3 (WILD Effect), which is called to execute in Step S16 of game execution processing shown in FIG. 8.

In the win determination processing 3, the CPU 50 first determines whether a bonus game has been triggered or not (Step S100). In the processing, the CPU 50 determines whether the rearranged symbol combination matches a winning combination for triggering a bonus game. In a case where the CPU 50 determines that a bonus game has been triggered, the CPU 50 calls bonus game processing (see FIG. 11 described later) (Step S101). Thereafter, the CPU 50 terminates the present processing.

On the other hand, in a case where the CPU 50 determines that a bonus game has not been triggered in Step S100, the CPU 50 determines whether the combination of symbols is a winning combination or not (Step S102). In this processing, the CPU 50 determines whether the rearranged symbol combination matches a winning combination. In a case where the combination matches a winning combination, the CPU 50 calls payout processing (see FIG. 12 or 17 described later) (Step S103). Thereafter, the CPU 50 terminates the present processing. In the payout processing, the CPU 50 also performs payout processing for occurrence of a “supplemented combination”, as described later.

In a case where the CPU 50 determines that the rearranged symbol combination does not match a winning combination in Step S102, the CPU 50 determines whether the rearranged symbol combination matches “a REACH combination and WILD” or not (Step S104). Here, “REACH combination” refers to a winning combination including symbols displayed on the first reel 22L and the second reel 22C together with WILD. For example, a REACH combination in S110 of FIG. 33 is “BAR BAR”. In addition, an “supplemented combination”, as described later, refers to a symbol combination in which symbols included in a REACH combination are displayed on the first reel 22L, the second reel 22C, and the third reel 22R. For example, in a case where a “REACH combination” is “BAR BAR”, the “supplemented combination” is “BAR BAR BAR”.

Next, in Step S105, the CPU 50 determines whether a REACH combination stored in the RAM 52 previously is the same as the current rearranged REACH combination or not. In a case where the CPU 50 determines that those combinations are different from each other, the CPU 50 advances the processing to Step S106. That is, in a case where a “REACH combination and WILD” is achieved after the rearrangement, the CPU 50 consistently stores the REACH combination as a symbol applicable to payout rate change. Then, the REACH combination is stored in the RAM 52 and retained even in subsequent games. Here, the symbol applicable to payout rate change refers to a symbol combination for which a payout rate is changed as shown in FIG. 33.

In a case where the CPU 50 determines that those combinations are different from each other, the CPU 50 sets a symbol applicable to payout rate change to an supplemented combination corresponding to the current REACH combination in Step S106. Thereafter, the CPU 50 advances the processing to Step S108.

On the other hand, in a case where the CPU 50 determines that those combinations are identical with each other, the CPU 50 changes a payout rate to be used when an supplemented combination is achieved. In other words, the CPU 50 changes a payout rate for credits which are paid out when a player wins an supplemented combination (Step S107).

Next, after the processing of Step S106 or Step S107, the CPU 50 provides credits to be paid out when the supplemented combination is achieved in Step S108. Thereafter, the CPU 50 terminates the present processing.

### HALF WILD Effect

FIG. 33 shows a transition of images depicting the HALF WILD effect displayed on the main display 4. Here, a HALF WILD symbol differs from a WILD symbol in that an amount of payout for a HALF WILD combination is half the amount of payout for a WILD combination. However, a symbol on the third reel 22R serves as a wild card in the HALF WILD combination, which is the same as that in the WILD combination. Therefore, although a description is made regarding HALF WILD in the following embodiments, the description is also applicable to a description regarding WILD.

If a REACH combination and a “HALF WILD” symbol are arranged and the same REACH combination and a “HALF WILD” symbol are rearranged while performing a HALF WILD effect, the payout rate is increased. On the other hand, in a case where a different REACH combination and a “HALF WILD” symbol are rearranged, a symbol applicable to payout rate change is updated. In FIG. 33, it is assumed that the payout is 100 credits for the rearranged symbol combination of “BAR BAR BAR”, and the payout is 200 credits for the rearranged symbol combination of “7, 7, 7”.

FIG. 33 (S110) shows that a symbol applicable to payout rate change is “BAR” and a payout rate of double is set for an occurrence of the combination “BAR, BAR, HALF WILD”. In addition, FIG. 33 shows that since the combination thus achieved includes a “HALF WILD” symbol, 50 credits, which is half of 100, is obtained.

FIG. 33 (S111) shows that 200 credits, which is double of 100 credits, has been obtained for an occurrence of the combination “BAR, BAR, BAR”.

FIG. 33 (S112) shows that as a result of a recurrence of the combination “BAR, BAR, HALF WILD” following Step S110, which is the same REACH combination, a payout rate to be paid when a winning combination is achieved is changed from double to triple.

FIG. 33 (S113) shows that 300 credits, which is triple of 100 credits, is obtained for the combination “BAR, BAR, BAR” occurred following Step S112.

FIG. 33 (S114) shows that as a result of an occurrence of the combination “7, 7, HALF WILD” following Step S110, whose REACH combination is “7, 7”, a symbol applicable to payout rate change is updated from “BAR, BAR, BAR” to “7, 7, 7”, and the payout rate is double. FIG. 33 (S114) also shows that since the combination thus achieved includes a “HALF WILD” symbol, 100 credits, which is half of 200, is obtained.

In this case, a payout rate of the previous REACH combination “BAR, BAR, BAR” is reset, and its payout rate “×2” is not maintained for the subsequent occurrence of “BAR, BAR” REACH combination.

FIG. 33 (S115) shows that 400 credits, which is double of 200 credits, is obtained for an occurrence of the combination “7, 7, 7” following Step S114.

### Second Embodiment

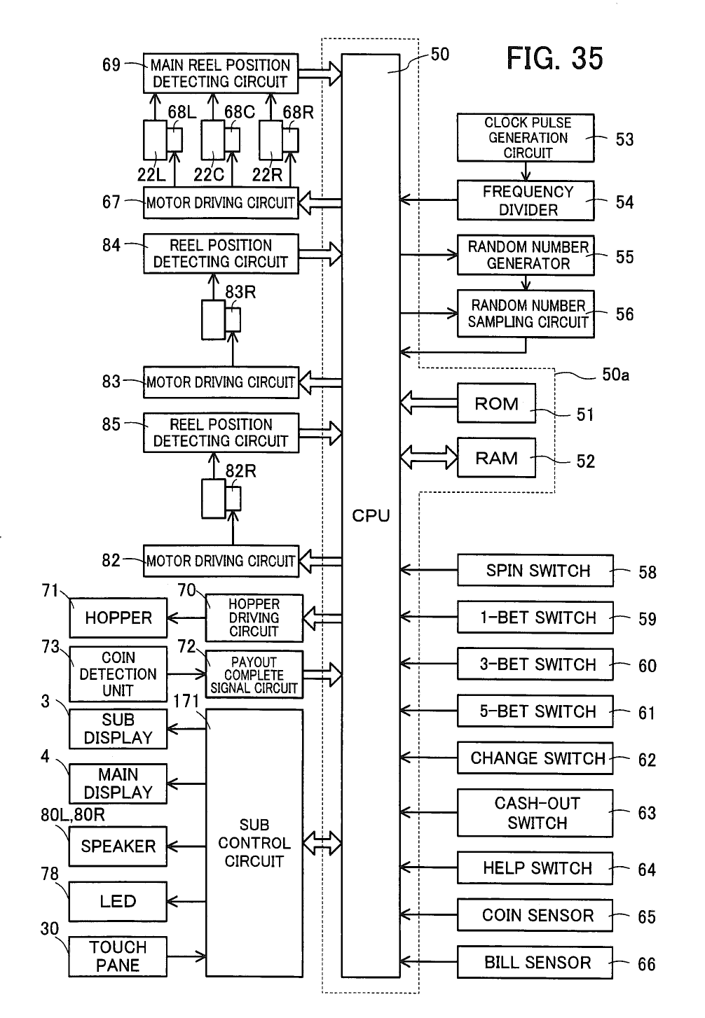

In the following, a slot machine 1 with a sub reel according to a second embodiment is described with reference to FIGS. 34 to 46. Firstly, the portions different from the first embodiment are described based on FIGS. 34 and 35 regarding the outline configuration of the slot machine 1 according to the present embodiment.

FIG. 34 is a perspective view of slot machine 1.

The slot machine 1 has a configuration in which a first sub reel 26 and a second sub reel 27 are added to the slot machine 1 of the first embodiment. The first sub reel 26 is provided on a main display 4. A symbol on the first sub reel 26 is rotated and rearranged upon a rearrangement of three reels 23, 24, and 25. The second sub reel 27 is provided on a sub display 3. A symbol on the second sub reel 27 is rotated and rearranged upon a rearrangement of the first sub reel 26.

FIG. 35 is a block diagram schematically showing a control system of the slot machine 1. With such a configuration in which the first sub reel 26 and the second sub reel 27 are added to the slot machine 1 of the first embodiment, the following are additional components: a motor driving circuit 82, a stepping motor 82R, and a reel position detecting circuit 85 for the first sub reel 26; and a motor driving circuit 83, a stepping motor 83R, and a reel position detecting circuit 84 for the second sub reel 27.

### Example of First Sub Reel

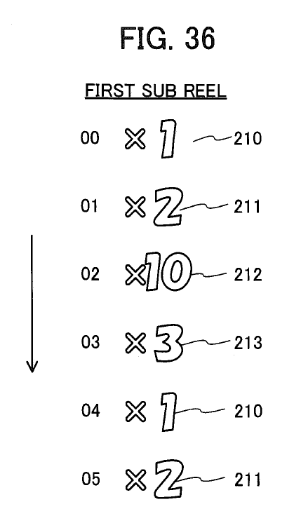

Examples using the first sub reel 26 are described with reference to FIGS. 36 to 39.

### Symbol Arrangement of First Sub Reel

FIG. 36 is a diagram showing a symbol and a code number displayed on the first sub reel 26. FIG. 36 shows one example of a symbol line in which six pieces, a plurality of types of symbols, are arranged on the first sub reel 26. This arrangement is converted into a table as data, and stored in the ROM 51 (see, FIG. 35). Code numbers of “00” to “05” are given to each symbol, as shown in FIG. 36, and stored in the ROM 51 as a data table (see FIG. 35). That is, it is possible to specify a symbol uniquely by identification of the first sub reel 26 and the code number.

On a peripheral surface of the first sub reel 26, four types of symbols are arranged as shown in FIG. 36. More specifically, symbols arranged on the peripheral surface of the first sub reel 26 are a “×1” symbol 210, “×2” symbol 211, “×10” symbol 212, and “×3” symbol 213. On a peripheral surface of the first sub reel 26, these four types of symbols are arranged in the order shown in FIG. 36. The first sub reel 26 is driven to rotate in such a manner that the symbol line moves in an arrow direction of FIG. 36.

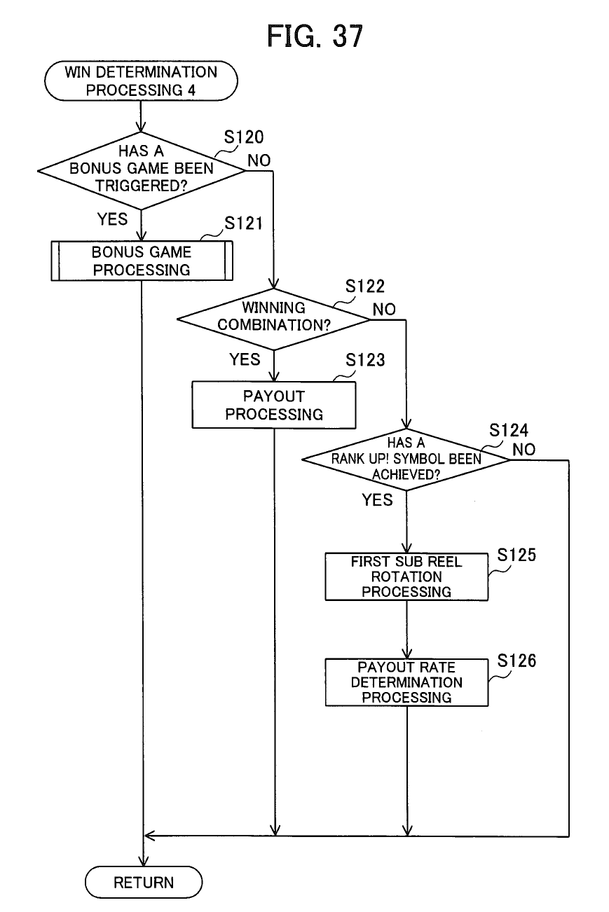

FIG. 37 is a flowchart showing a subroutine of win determination processing 4, which is called to execute in Step S16 of game execution processing shown in FIG. 8.

In win determination processing 4, CPU 50 first determines whether a bonus game has been triggered or not (Step S120). In the processing, the CPU 50 determines whether the rearranged symbol combination matches a winning combination for triggering a bonus game. In a case where the CPU 50 determines that a bonus game has been triggered, the CPU 50 calls bonus game processing (see FIG. 11) (Step S121). Thereafter, the CPU 50 terminates the present processing.

On the other hand, in a case where the CPU 50 determines that the bonus game has not been triggered in Step S120, the CPU 50 determines whether or not a player has won any award (Step S122). In this processing, the CPU 50 determines whether the rearranged symbol combination matches a winning combination. In a case where the rearranged symbol combination matches a winning combination, the CPU 50 calls payout processing (see FIG. 12 or 17) (Step S123). Thereafter, the CPU 50 terminates the present processing.

On the other hand, in Step S122, in a case where the CPU 50 determines that the rearranged symbol combination does not match a winning combination, the CPU 50 then determines whether the rearranged symbol combination achieves “RANK UP” or not (Step S124). In a case where the CPU 50 determines that a symbol is “RANK UP!”, the CPU 50 performs the first sub reel rotation processing (Step S125). Next, the CPU 50 performs payout rate determination processing when a supplemented combination is achieved (Step S126). The “supplemented combination” here may be the same as that described in WILD of the first embodiment 1. Alternatively, the CPU 50 may determine in advance a predetermined combination as a supplemented combination. Thereafter, the CPU 50 terminates the present processing.

In a case where the first sub reel 26 is rotated again after the rearrangement, the payout rate determined previously based on the payout rate determination processing (S126) is reset. A new payout rate is determined based on the result of a rearrangement of the first sub reel 26, which is newly driven to rotate.

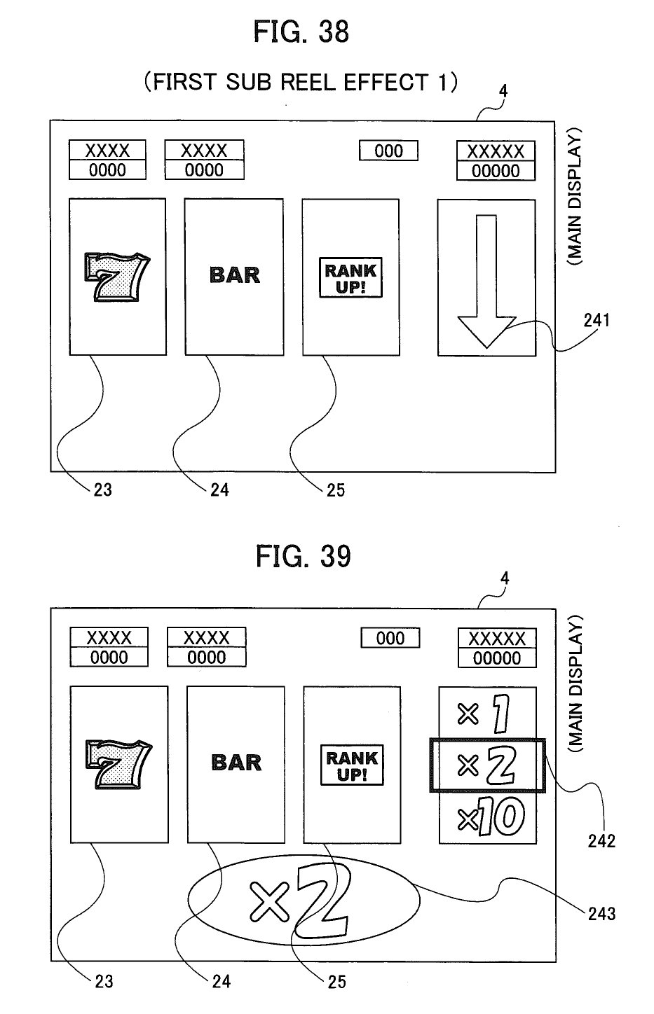

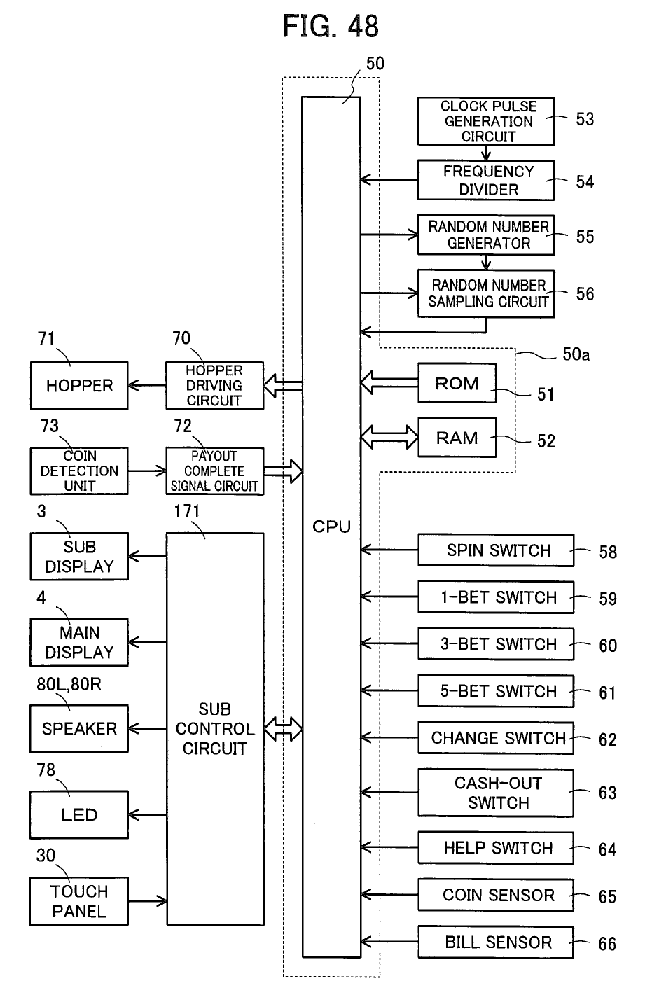

FIG. 38 is an example of an image of the first sub reel effect 1 displayed on the main display 4. The image shown in FIG. 48 indicates a rearrangement of symbols and the resulting combination “7, BAR, RANKUP!” displayed in the left display window 23, the center display window 24, and right display window 25, respectively. An arrow 241 of the first sub reel 26 indicates that the first sub reel 26 is rotating, following an occurrence of a “RANK UP!” symbol.

FIG. 39 is an example of an image of the first sub reel effect 1 displayed on the main display 4 in a case where a game has been executed and advanced from FIG. 38. The image shown in FIG. 39 indicates the rotation of the first sub reel 26, a rearrangement of symbols, and the resulting appearance of a “×1” symbol, a “×2” symbol, and a “×10” symbol. A frame 242 on the first sub reel 26 and a “×2” symbol 243 indicate that the determined payout rate is “×2”.

### Examples of First and Second Sub Reels

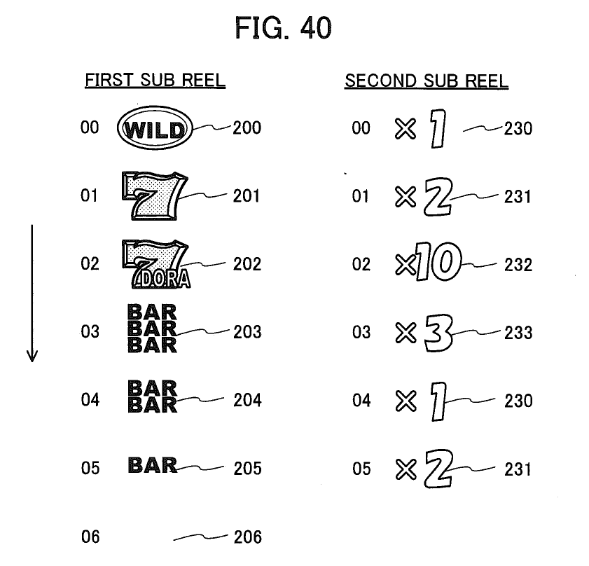

Examples using the first and second sub reels are described with reference to FIGS. 40 to 46.

### Symbol Arrangement of the First and Second Sub Reels

FIG. 40 shows symbols and code numbers displayed on the first sub reel 26 and the second sub reel 27. FIG. 40 shows one example of a symbol line in which seven pieces, a plurality of types of symbols, are arranged on the first sub reel 26. This arrangement is converted into a table as data, and stored in the ROM 51 (see, FIG. 35). More specifically, code numbers of “00” to “06” are given to each symbol, as shown in FIG. 40, and stored in the ROM 51 as a data table (see FIG. 35). That is, it is possible to specify a symbol uniquely by identification of the first sub reel 26 and the code number.

On a peripheral surface of the first sub reel 26, seven types of symbols including a blank symbol are formed, as shown in FIG. 40. More specifically, symbols formed on the peripheral surface of the first sub reel 26 are a WILD symbol 200, a RED 7 symbol 201, a 7 DORA symbol 202, a 3 BAR symbol 203, a 2 BAR symbol 204, a BAR symbol 205, and a blank symbol 206. These seven types of symbols are arranged in the order shown in FIG. 40. The first sub reel 26 is driven to rotate in such a manner that the symbol line moves in the arrow direction of FIG. 40.

FIG. 40 shows one example of a symbol line in which six pieces, a plurality of types of symbols, are arranged on the second sub reel 27, respectively. This arrangement is converted into a table as data, and stored in the ROM 51 (see, FIG. 35). Code numbers of “00” to “06” are given to each symbol, as shown in FIG. 40, and stored in the ROM 51 as a data table (see, FIG. 35). That is, it is possible to specify a symbol uniquely by identification of the second sub reel 27 and the code number.

On a peripheral surface of the second sub reel 27, four types of symbols are formed, as shown in FIG. 40. More specifically, symbols arranged on the peripheral surface of the second sub reel 27 are a “×1” symbol 230, “×2” symbol 231, “×10” symbol 232, and “×3” symbol 233.

These four types of symbols are arranged in the order shown in FIG. 40. The second sub reel 27 is driven to rotate in such a manner that the symbol line moves in the arrow direction of FIG. 40.

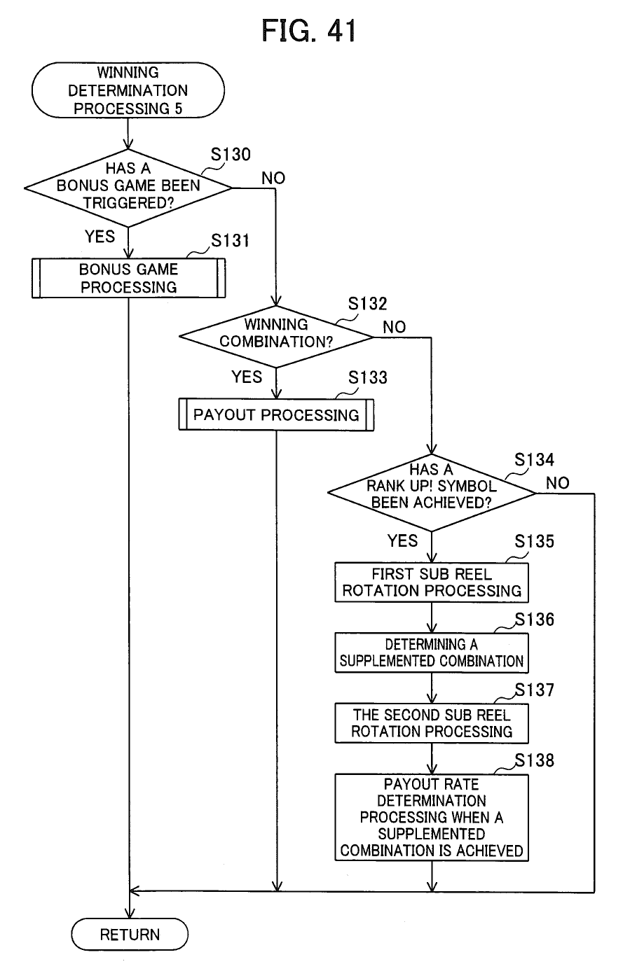

FIG. 41 is a flowchart showing a subroutine of win determination processing 5, which is called to execute in Step S16 of game execution processing shown in FIG. 8. In win determination processing 5, the CPU 50 first determines whether a bonus game has been triggered or not (Step S130). In the processing, the CPU 50 determines whether the rearranged symbol combination matches a winning combination for triggering a bonus game. In a case where the CPU 50 determines that a bonus game has been triggered, the CPU 50 calls bonus game processing (see FIG. 11) (Step S131). Thereafter, the CPU 50 terminates the present processing.

On the other hand, in a case where the CPU 50 determines that the bonus game has not been triggered in Step S130, the CPU 50 determines whether or not a player has won any award (Step S132). In this processing, the CPU 50 determines whether the rearranged symbol combination matches a winning combination. In a case where the rearranged symbol combination matches a winning combination, the CPU 50 calls payout processing (see FIG. 12 or 17) (Step S133). Thereafter, the CPU 50 terminates the present processing.

On the other hand, in Step S132, in a case where the CPU 50 determines that the rearranged symbol combination does not match a winning combination, the CPU 50 then determines whether the rearranged symbol combination achieves “RANK UP” or not (Step S134). In a case where the CPU 50 determines that a “RANK UP!” symbol is achieved, the CPU 50 performs the first sub reel rotation processing (Step S135). Then, the CPU 50 determines a supplemented combination (Step S136). Next, the CPU 50 performs the second sub reel rotation processing (Step S137). Then, the CPU 50 performs processing for determining a payout rate to be used when a supplemented combination is achieved. Thereafter, the CPU 50 terminates the present processing.

On the other hand, in Step S134, in a case where the CPU 50 determines that a “RANK UP!” symbol has not been achieved, the CPU 50 terminates the present processing.

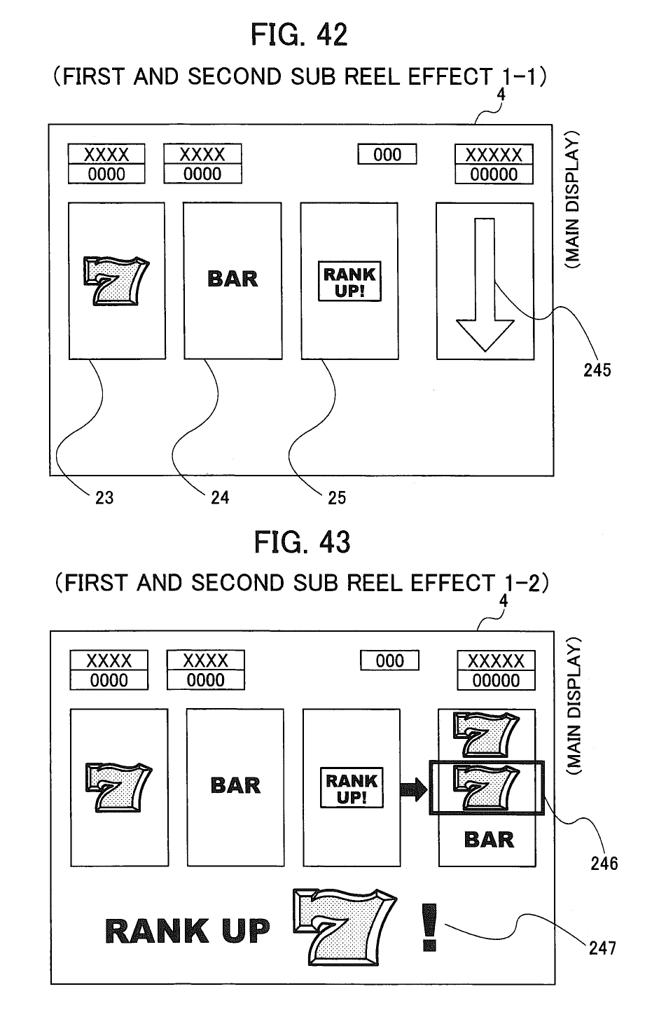

FIG. 42 is an example of an image of the first and second sub reels effect 1 displayed on the main display 4. The image of the first and second sub reels effect 1-1 indicates a rearrangement of symbols and the resulting combination “7, BAR, RANK UP!” displayed in the left display window 23, the center display window 24, and the right display window 25, respectively. An arrow 245 of the first sub reel 26 indicates that the first sub reel 26 is rotating as a result of an appearance of a “RANK UP!” symbol.

FIG. 43 is an example of an image of the first and second sub reels effect 1 displayed on the main display 4 in a case where a game has been executed and advanced from FIG. 42. The image of the first and second sub reels effect 1-2 shown in FIG. 43 indicates the rotation of the first sub reel 26, a rearrangement of symbols, and the resulting appearance of a “7” symbol, a “7” symbol, and a “BAR” symbol. Then, a frame 246 on the first sub reel 26 and a message “RANK UP7!” 247 indicate that a “7” symbol is selected. Consequently, a supplemented combination is determined to be “7, 7, 7”.

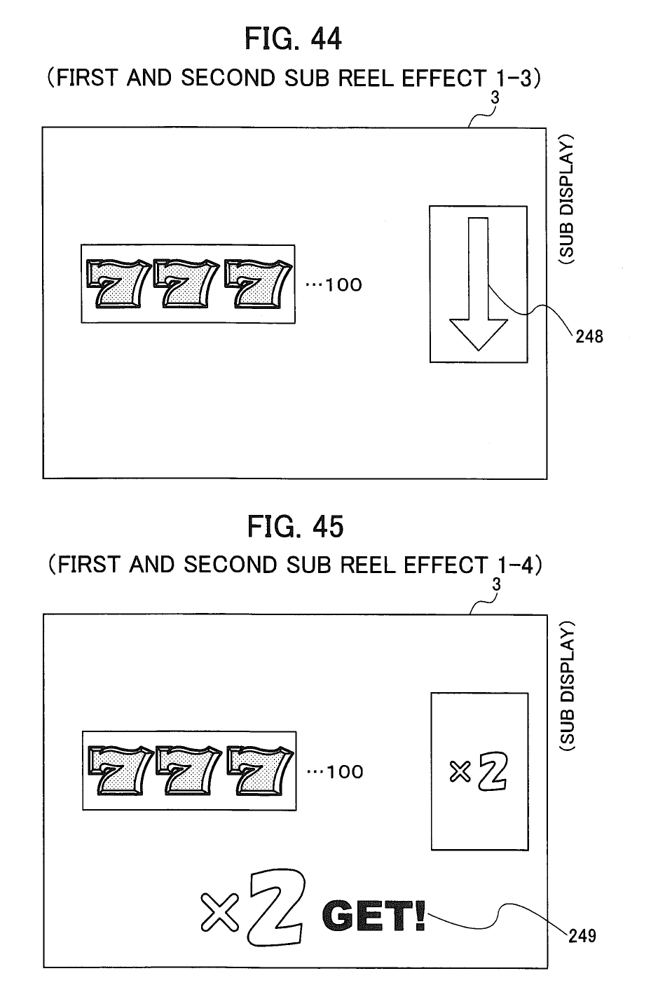

FIG. 44 is an example of an image of the first and second sub reels effect 1 displayed on the sub display 3 in a case where a game has been executed and advanced from FIG. 43. The image of the first and second sub reels effect 1-3 shown in FIG. 44 depicts an arrow 248 of the second sub reel indicating that the second sub reel 27 is rotating.

FIG. 45 is an example of an image of the first and second sub reels effect 1 displayed on the sub display 3 in a case where a game has been executed and advanced from FIG. 44. The image of the first and second sub reels effect 1-4 shown in FIG. 45 indicates a rearrangement of a symbol on the second sub reel 27 and the determination of the resulting symbol “×2”. A message “×2 GET!” 249 indicates that a payout rate of double is used when the supplemented combination “7, 7, 7” is achieved.

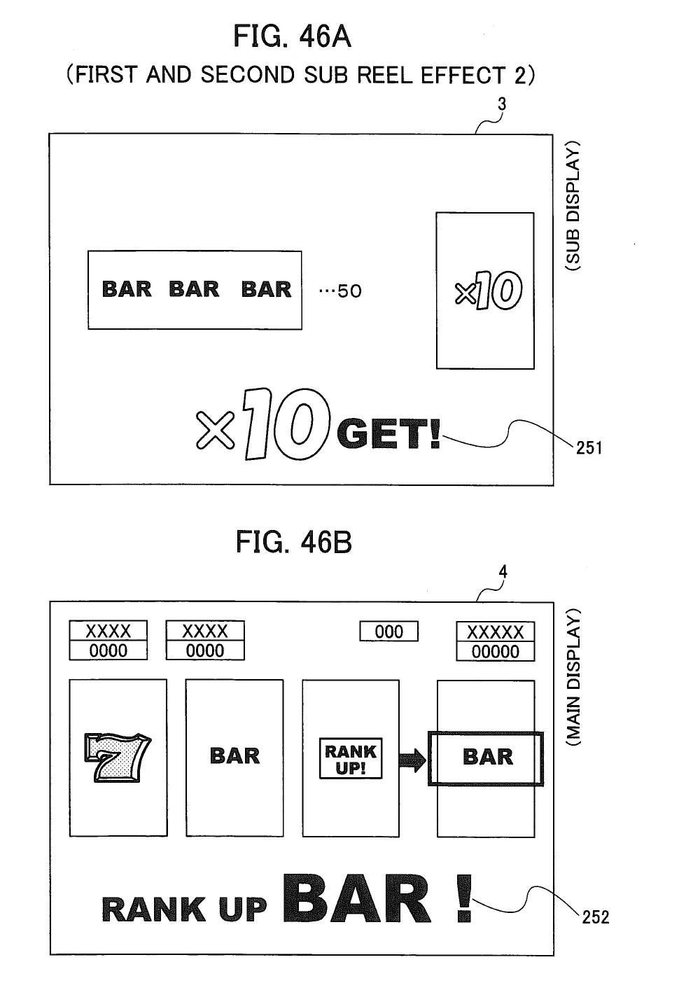

FIGS. 46A and 46B are an example of images of the first and second sub reels effect 2 displayed on the main display 4 and the sub display 3. The image shown in FIG. 46B indicates that a “RANK UP!” symbol appears while performing the first and second sub reels effect 2. In order to explain operations, a main display of FIG. 46B is described first.

FIG. 46B is an example of an image of the first and second sub reels effect 2 displayed on the main display 4.

The image shown in FIG. 48 indicates a rearrangement of symbols and the resulting combination “7, BAR, RANKUP!” displayed in the left display window 23, the center display window 24, and right display window 25, respectively. FIG. 46B also indicates that symbols are rearranged and a “BAR” symbol is achieved. Consequently, a message “RANK UP BAR!” indicates that a supplemented combination is determined to be “BAR, BAR, BAR”. After the supplemented combination is determined on the first sub reel 26, the second sub reel 27 starts rotation.

FIG. 46A is an example of an image of the first and second sub reels effect 2 displayed on the sub display 3. The image shown in FIG. 46A indicates a rearrangement of a symbol on the second sub reel 27 and the resulting symbol “×10”. A message “×10 GET!” 251 indicates that when the supplemented combination “BAR, BAR, BAR” is achieved, a player wins a payout rate of tenfold. Although the abovementioned first and second sub reels 26 and 27 are described as mechanical reels, those may alternatively be virtual reels displayed on the main display 4.

### Third Embodiment

A video slot 1 according to a third embodiment is described with reference to FIGS. 47 to 51. Firstly, the different portions from the first embodiment are described based on FIGS. 47 and 48 regarding the outline configuration of the video slot 1 according to the present embodiment.

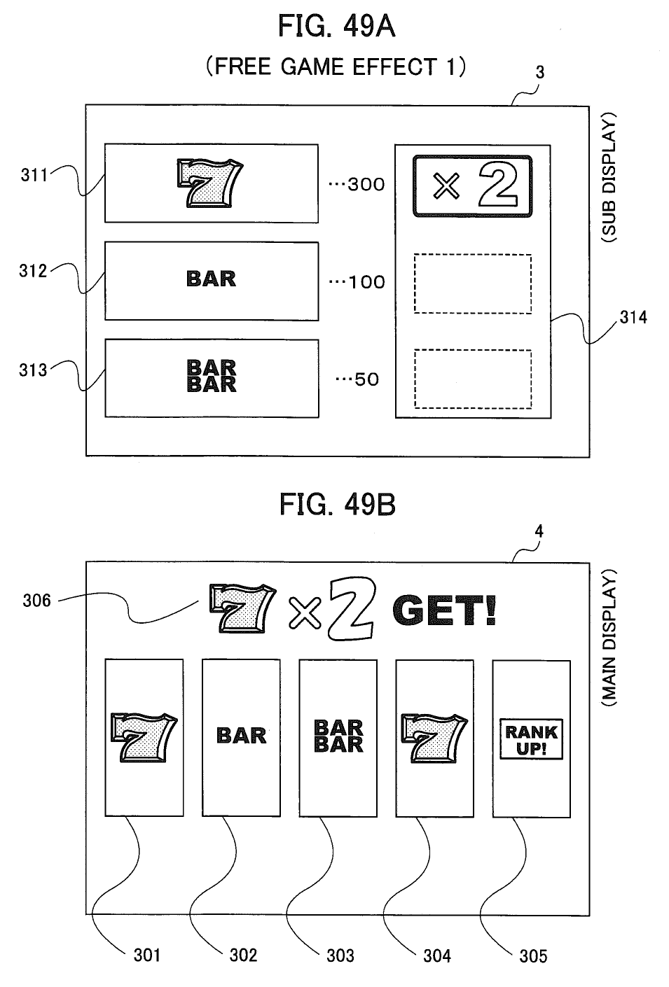

FIG. 47 is a perspective view of the video slot 1. The video slot 1 is different from the slot machine 1 of the first embodiment in that the video slot 1 does not have display windows 23, 24, and 25 since the video slot 1 does not have reels 22L, 22C, and 22R. Symbols are arranged in a symbol display frame provided on a display. In the case of the present embodiment, five symbol display frames 301, 302, 303, 304, and 305 are provided on the display (see FIG. 49 described later).

FIG. 48 is a block diagram schematically showing a control system of the video slot 1. The video slot 1 does not include a reel, a stepping motor, or a reel position detecting circuit, which is different from the slot machine 1 of the first embodiment.

FIGS. 49A and 49B are an example of images showing a free game effect 1 displayed on the main display 4 and the sub display 3. Similar to the bonus game shown in the flowchart of FIG. 11, a free game is performed in such a manner that a predetermined number of free games are performed, and when a winning combination with a symbol applicable to payout rate change is achieved, a payout is performed based on a payout rate thus determined. These winning combination and payout rate are determined by lottery in the free game effect 1. Then, a free game is started and a payout is performed in a free game effect 2. The images of the free game effect 1 shown in FIGS. 49A and 49B indicate that the winning combination with a symbol applicable to payout rate change is “7”, and the payout rate is “×2”. These results are determined through a rearrangement of symbols, an appearance of “RANK UP!” symbol, and a lottery performed as a result of the appearance of “RANK UP!” symbol, which is intended to determine a winning combination with a symbol applicable to payout rate change and a predetermined payout rate.

FIG. 49A is an example of an image of the free game effect 1 displayed on the sub display 3. The image shown in FIG. 49A indicates that a symbol “7” 311 with the payout rate “×2” is selected among a symbol “7” 311, a symbol “BAR” 312, and a symbol “BAR” 313. This selection is performed through a rearrangement of symbols in a symbol display frame 314 of the sub display 3 following an appearance of “RANK UP!” symbol on the main display 4.

FIG. 49B is an example of an image of the free game effect 1 displayed on the main display 4. The image shown in FIG. 49B indicates a rearrangement of symbols in the symbol display frames 301, 302, 303, 304, and 305 and the resulting combination of symbols “7, BAR, BARBAR, 7, RANK UP!”, each symbol displayed in each frame. The image also shows a message “7×2 GET!” 306 indicating that a player obtains the payout rate of double for an amount of payout for a symbol combination “7, 7, 7, 7, 7”.

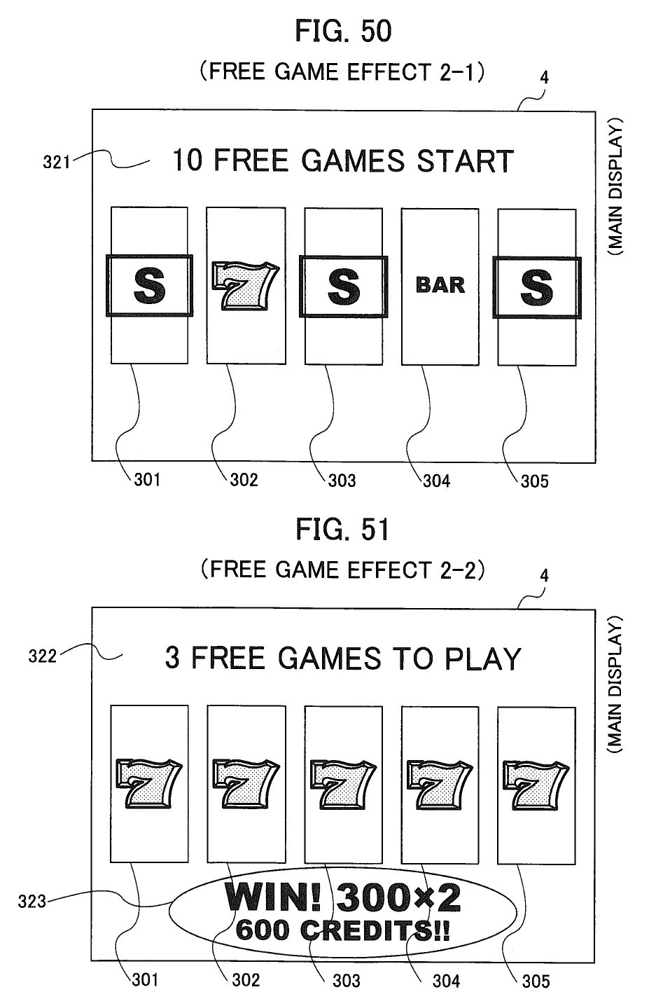

FIG. 50 is an example of an image of a free game effect 2 displayed on the main display 4. In the free game effect 2, symbols are rearranged, and when scatter symbols “S” appear in three windows, a free game starts. When a winning combination with a symbol applicable to payout rate change is achieved, a payout is conducted based on a determined payout rate. The image of the free game effect 2-1 shown in FIG. 50A shows an rearrangement of symbols and the resulting combination “S, 7, S, BAR, S” displayed in the symbol display windows 301, 302, 303, 304, and 305 respectively. The image also shows an appearance of scatter symbols “S” in the three windows and a message “10 FREE GAMES START” 321 indicating that the number of free games determined is ten.

FIG. 51 is an example of an image of the free game effect 2 displayed on the main display 4 in a case where a game was executed and progressed from FIG. 50. The image shows a rearrangement of symbols and the resulting combination “7, 7, 7, 7, 7” displayed in the symbol display windows 301, 302, 303, 304, and 305 respectively. The image also shows a message “FREE GAME 3 GAMES TO GO” 322 indicating that the remaining number of free games is three. In addition, the image shows a message “WIN! 300×2 600 CREDITS!!” 323 indicating that 600 credits are paid out, which is double the payout of a “7, 7, 7, 7, 7” combination having a payout of 300 credits, based on the free game effect 1, which determines a symbol “7” applicable to payout rate change and the payout rate “×2”.

### Another Variation: Progressive Payout

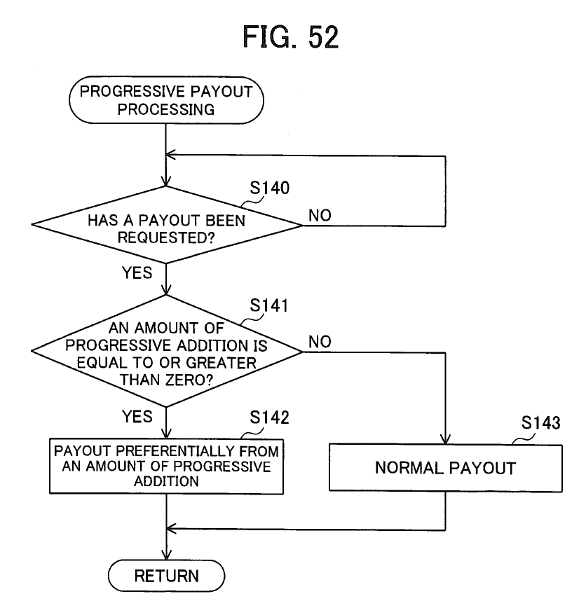

FIG. 52 is a flowchart showing a subroutine of progressive payout processing. FIG. 52 shows an example of payout processing which is called and executed in progressive payout processing.

In progressive payout processing, the CPU 50 first determines whether a payout is requested or not (Step S140). In a case where the CPU 50 determines that a payout is not requested, the CPU 50 returns the processing to Step S140.

On the other hand, in Step S140, in a case where the CPU 50 determines that a payout is requested, the CPU 50 then determines whether or not an amount of progressive addition is equal to or greater than zero (Step S141).

In Step S141, in a case where the CPU 50 determines that the amount of progressive addition is equal to or greater than zero, the CPU 50 performs a payout preferentially from the amount of progressive addition (Step S142). Thereafter, the CPU 50 terminates the present processing.

On the other hand, in Step S141, in a case where the CPU 50 determines that the amount of progressive addition is not equal to or greater than zero, the CPU 50 performs a normal payout (Step S143). Thereafter, the CPU 50 terminates the present processing.

### Another Variation: Trigger Rendered Effect 4

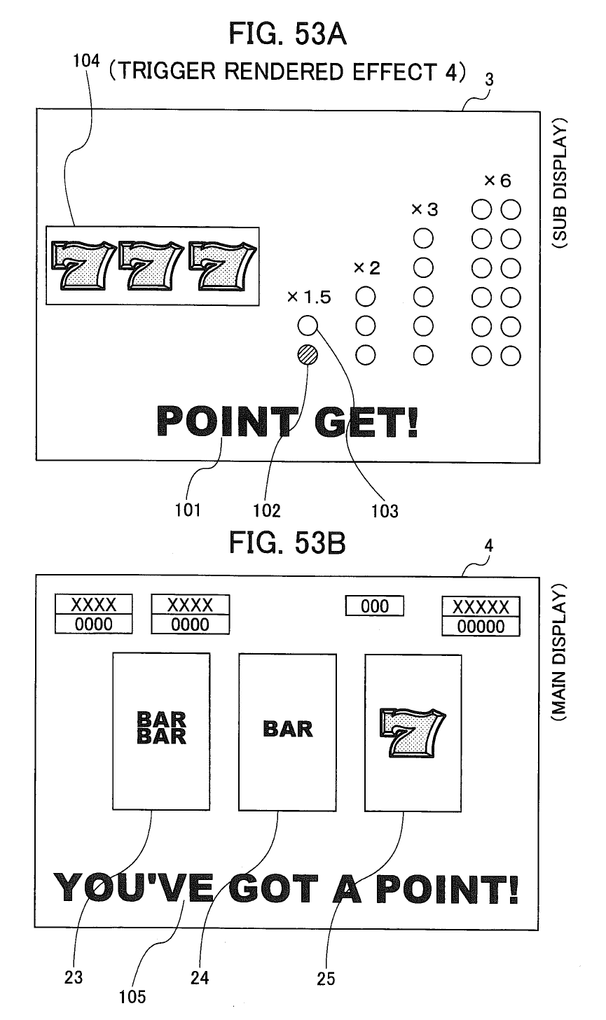

FIGS. 53A and 53B are an example of images showing the trigger rendered effect 4 displayed on the main display 4 and the sub display 3. The images show an addition of points for a case where a combination falls into a predetermined losing symbol combination. Since points are added even if a combination falls into a predetermined losing symbol combination, a situation in which a player loses interest in the amusement service is prevented. A predetermined losing symbol combination may be determined in advance or may alternatively be determined at predetermined timing by lottery.

FIG. 53A is an example of an image of the trigger rendered effect 4 displayed on the sub display 3. The image indicates that 1.5 times as the amount of a normal payout is paid out for a symbol combination “7, 7, 7”, and the obtained point is one.

FIG. 53B is an example of an image of the trigger effect 4 displayed on the main display 4. The image shows a rearrangement of symbols and the resulting predetermined losing symbol combination “BAR BAR, BAR, 7”, which does not fall into any predetermined winning combination, displayed on the left display window 23, the center display window 24, and the right display window 25. FIG. 53B indicates that since the rearranged symbol combination matches the predetermined losing symbol combination, a player is allowed to earn points.

The present example does not explicitly describe the case in which point value added by a “RANK UP!” symbol exceeds the threshold with the state of “777 300×2” in the RANK UP effect 1. In this case, an amount of payout credits of BARBAR may be upgraded to “BARBAR BARBAR BARBAR—100”. Accordingly, since an amount of payout credits may possibly be updated when a “RANK UP!” symbol is rearranged, a situation in which a player loses interest in the amusement service is prevented.

Although the embodiments are described above for the purpose of exemplification, they are not intended to limit the present invention. For example, the present invention is not limited to a symbol combination displayed on the reels 22L, 22C, and 22R of a slot machine and the like, and can be applied to a symbol combination of a table game (such as a card game and a mahjong game). Designs of various elements thereof also can be modified appropriately. In addition, the advantages, which are shown in the embodiments, are simply listed as most preferable advantages generated from the embodiments, and the advantages according to this invention are not limited to what have been described. In addition, a payout rate and other numerical values may be changed arbitrarily for the purpose of heightening and modifying the gaming nature of the slot machine 1 or video slot 1.

What is claimed is:

1. A gaming machine that pays an amount of game media for an occurrence of a predetermined combination of symbols as a result of a game, comprising:
a display device for performing a variable display and a statical display of a plurality of symbols;
a memory; and
a controller configured with logic to:
(a) determine a combination of symbols to be displayed on the display device as a result of a game by performing a lottery in response to acceptance of manipulation to start the game by a player;
(b) cause the display device to perform a variable display of the plurality of symbols;
(c) cause the display device to perform a statical display of the plurality of symbols in accordance with a result of the lottery;
(d) when the statical display of the plurality of symbols matches a specific combination of symbols, control the memory to cumulatively store points, a number of the points being smaller than a threshold that is required for performing a special program that is adapted to provide profits to the player, wherein
when a summation of the points cumulatively stored in the memory has reached the threshold, the controller executes the special program.

2. A method for playing a game that pays an amount of game media for an occurrence of a predetermined combination of symbols as a result of the game, comprising:
(a) accepting manipulation to start a game by a player;
(b) starting the game in response to step (a);
(c) determining a combination of symbols to be displayed on a display device that performs a variable display and a statical display of a plurality of symbols as a result of a game by performing a lottery;
(d) causing the display device to perform a variable display of the plurality of symbols;
(e) causing the display device to perform a statical display of the plurality of symbols in accordance with a result of the lottery;
(f) when the statical display of the plurality of symbols matches a specific combination of symbols, controlling a memory to cumulatively store points that are required for performing a special program that is adapted to provide profits to the player; and
(g) when a summation of points cumulatively stored in the memory has reached a threshold, executing the special program.
